(19) United States
(12) Patent Application Publication
(10) Pub. No.: US 2012/0231489 A1
(43) Pub. Date: Sep. 13, 2012

(54) IRIDESCENT SURFACES AND APPARATUS FOR REAL TIME MEASUREMENT OF LIQUID AND CELLULAR ADHESION

(75) Inventor: STEVEN LENHERT, Tallahassee, FL (US)

(73) Assignee: FLORIDA STATE UNIVERSITY RESEARCH FOUNDATION, TALLAHASSEE, FL (US)

(21) Appl. No.: 13/417,650

(22) Filed: Mar. 12, 2012

Related U.S. Application Data
(60) Provisional application No. 61/451,619, filed on Mar. 11, 2011.
(60) Provisional application No. 61/451,635, filed on Mar. 11, 2011.

(51) Int. Cl. G01N 21/47

(52) U.S. Cl. 435/29

(57) ABSTRACT

Described is a method and apparatus for determining the adhesion of an object to an iridescent surface based on the detected scattered light scattered by the interface region for the iridescent surface and the object.

### CROSS-REFERENCE TO RELATED APPLICATIONS

This application claims benefit of priority to the following applications: U.S. Provisional Application No. 61/451619, to Lenhert, entitled “IRIDESCENT SURFACES AND APPARATUS FOR REAL TIME MEASUREMENT OF LIQUID AND CELLULAR ADHESION,” filed Mar. 11, 2011; U.S. Provisional Application No. 61/451,635, to Lenhert et al., entitled “METHODS AND APPARATUS FOR LIPID MULTILAYER PATTERNING,” filed Mar. 11, 2011; and U.S. patent application Ser. No. 13/417,588 to Lenhert et al., entitled “METHODS AND APPARATUS FOR LIPID MULTILAYER PATTERNING,” filed Mar. 12, 2012, and the entire contents and disclosures of these applications are incorporated herein by reference in their entirety.

### BACKGROUND

1. Field of the Invention

The present invention relates to measuring adhesion of objects to surfaces.

2. Related Art

It has been difficult to measure cell adhesion to various surfaces.

### SUMMARY

According to a first broad aspect, the present invention provides a method comprising the following step: (a) determining the adhesion of an object to an iridescent surface based on scattered light detected by a detector, wherein the scattered light is formed by scattering one or more incident lights by an interface region for the object and the iridescent surface.

### BRIEF DESCRIPTION OF THE DRAWINGS

The accompanying drawings, which are incorporated herein and constitute part of this specification, illustrate exemplary embodiments of the invention and, together with the general description given above and the detailed description given below, serve to explain the features of the invention.

FIG. 1 is a schematic drawing of the relationship between surface geometry and cell behavior.

FIG. 2 is diagram showing the overlap in material functionality based on optical properties, physical adhesion and cell adhesion.

FIG. 3 is schematic drawing of two etching processes using phospholipid monolayers as etch resists.

FIG. 4 is a combination of schematic drawing of different tips in a parallel array integrating different inks on a surface (top) and a fluorescence micrograph of phospholipid patterns (bottom).

FIG. 5 is an image of anisotropic spreading of dye-containing water droplets on a smooth control surface (left) and a grooved surface (right).

FIG. 6 is a graph of water drop anisotropy plotted as a function of the roughness factor for 12 different groove topographies.

FIG. 7 is a micrograph of gratings of different pitch illuminated from ˜30° and observed through a microscope objective.

FIG. 8 is an atomic force microscope (AFM) topography of a 600 nm grating.

FIG. 9 is a graph of correlation of multilayer height to diffraction efficiency up to grating heights of 50 nm.

FIG. 10 are two images showing spreading of microscopic lipid droplets of three different lipid compositions, neutral, negatively charged and positively charged, printed on the same surface with Dip-Pen Nanolithography® (DPN®; Dip-Pen Nanolithography and DPN are registered trademarks of Nanoink).

FIG. 11 is an image of an osteoblast cell aligned with a grooved topography and stained for vinculin (a component in focal adhesions).

FIG. 12 is an image of a supported phospholipid multilayer square with dimensions of topographical surface (grooved polystyrene), showing anisotropic spreading of comparable dimensions.

FIG. 13 is a schematic diagram of three effects observed as a result of lipid adhesion to a substrate and interaction with protein from solution.

FIG. 14 is a fluorescence micrograph showing spreading of a lipid in air after 5 minutes of exposure to humidity above 40%.

FIG. 15 is a fluorescence micrograph showing dewetting of smooth lines of biotin-containing gratings under solution to form droplets after 1 minute of exposure to the protein streptavidin.

FIG. 16 is a fluorescence micrograph showing intercalation of protein into lipid multilayer grating lines of different heights after 1 hour of intercalation.

FIG. 17 shows the chemical structures of 1,2-dioleoyl-sn-glycero-3-phosphocholine (DOPC), a phospholipid, and 1,2-dioleoyl-sn-glycero-3-phosphoethanolamine-N-(lissamine rhodamine B sulfonyl) (DOPE-RB) used to make lipid multilayer gratings according to one embodiment of the present invention.

FIG. 18 is a graph showing label-free detection of protein binding by monitoring of the diffraction from gratings upon exposure to protein at different concentrations.

FIG. 19 is a fluorescence micrograph of immunofluorescently labeled osteoblast cells on a smooth polystyrene surface with the cytoskeletal protein actin labeled.

FIG. 20 is a fluorescence micrograph of immunofluorescently labeled osteoblast cells on polystyrene with 150 nm deep grooves at a pitch of 500 nm with the cytoskeletal protein actin labeled.

FIG. 21 is a fluorescence micrograph of immunofluorescently labeled osteoblast cells on a smooth polystyrene surface with the cytoskeletal protein actinin labeled.

FIG. 22 is a fluorescence micrograph of immunofluorescently labeled osteoblast cells on polystyrene with 150 nm deep grooves at a pitch of 500 nm with the cytoskeletal protein actinin labeled.

FIG. 23 is a fluorescence micrograph of immunofluorescently labeled osteoblast cells on a smooth polystyrene surface with the adhesion-related protein vinculin labeled.

FIG. 24 is a fluorescence micrograph of immunofluorescently labeled osteoblast cells on polystyrene with 150 nm deep grooves at a pitch of 500 nm with the adhesion-related protein vinculin labeled.

FIG. 25 is a fluorescence micrograph of immunofluorescently labeled osteoblast cells on a smooth polystyrene surface with the adhesion-related protein integrin (fibronectin receptor) labeled.

FIG. 26 is a fluorescence micrograph of immunofluorescently labeled osteoblast cells on polystyrene with 150 nm deep grooves at a pitch of 500 nm with the adhesion-related protein integrin (fibronectin receptor) labeled.

FIG. 27 is a schematic diagram of an inverted monitoring apparatus used for monitoring optical diffraction of an iridescent surface in the presence of adherent liquids, model systems and cells according to one embodiment of the present invention.

FIGS. 28, 29, 30 and 31 are time-lapse micrographs showing a water droplet being placed on an iridescent, molded polydimethylsiloxane (PDMS) surface using the apparatus of FIG. 27.

FIGS. 32, 33, 34 and 35 are time-lapse micrographs showing a water droplet dewetting from the molded surface PDMS of the apparatus of FIG. 27.

FIG. 36 is a brightfield image of cells stained with toluidine blue.

FIG. 37 is an image of the same area as FIG. 36 with light diffracted from a surface grating.

FIG. 38 is a schematic diagram of an upright monitoring apparatus for monitoring optical diffraction of an iridescent surface in the presence of adherent liquids, model systems and cells according to one embodiment of the present invention.

FIG. 39 is an image of an apparatus used to detect optical diffraction of an iridescent surface according to one embodiment of the present invention.

FIG. 40 is an image of part of a butterfly wing taken using light with an angle of incidence of 17.94° using the apparatus of FIG. 39.

FIG. 41 is an image of part of the butterfly wing of FIG. 40 taken using light with an angle of incidence of 57.62° using the apparatus of FIG. 39.

FIG. 42 shows a blue channel for the image of FIG. 40.

FIG. 43 shows a blue channel for the image of FIG. 41.

FIG. 44 shows a green channel for the image of FIG. 40.

FIG. 45 shows a green channel for the image of FIG. 41.

FIG. 46 shows a red channel for the image of FIG. 40.

FIG. 47 shows a red channel for the image of FIG. 41.

FIG. 48 is a graph of intensity vs. angle of incidence of a circled region of the image of FIG. 40.

FIG. 49 is a graph of intensity vs. angle of incidence of the entire area of the butterfly wing shown in FIGS. 40 and 41.

### DETAILED DESCRIPTION OF THE PREFERRED EMBODIMENTS

### Definitions

Where the definition of a term departs from the commonly used meaning of the term, applicant intends to utilize the definitions provided below, unless specifically indicated.

For purposes of the present invention, it should be noted that the singular forms “a,” “an” and “the” include reference to the plural unless the context as herein presented clearly indicates otherwise.

For purposes of the present invention, directional terms such as “top,” “bottom,” “upper,” “lower,” “above,” “below,” “left,” “right,” “horizontal,” “vertical,” “up,” “down,” etc., are used merely for convenience in describing the various embodiments of the present invention. The embodiments of the present invention may be oriented in various ways. For example, the diagrams, apparatuses, etc. shown in the drawing figures may be flipped over, rotated by 90° in any direction, reversed, etc.

For purposes of the present invention, a value or property is “based” on a particular value, property, the satisfaction of a condition, or other factor, if that value is derived by performing a mathematical calculation or logical decision using that value, property or other factor.

For purposes of the present invention, the term “analyte” refers to the conventional meaning of the term “analyte,” i.e., a substance or chemical constituent of a sample that is being detected or measured in a sample. In one embodiment of the present invention, a sample to be analyzed may be an aqueous sample, but other types of samples may also be analyzed using a device of the present invention.

For purposes of the present invention, the term “array” refers to a one-dimensional or two-dimensional set of microstructures. An array may be any shape. For example, an array may be a series of microstructures arranged in a line, such as an array of lines, an array of squares, etc. An array may be arranged in a square or rectangular grid. There may be sections of the array that are separated from other sections of the array by spaces. An array may have other shapes. For example, an array may be a series of microstructures arranged in a series of concentric circles, in a series of concentric squares, in a series of concentric triangles, in a series of curves, etc. The spacing between sections of an array or between microstructures in any array may be regular or may be different between particular sections or between particular pairs of microstructures. The microstructure arrays of the present invention may comprise microstructures having zero-dimensional, one-dimensional or two-dimensional shapes. The microstructures having two-dimensional shapes may have shapes such as squares, rectangles, circles, parallelograms, pentagons, hexagons, irregular shapes, etc.

For purposes of the present invention, the term “biomolecule” refers to the conventional meaning of the term biomolecule, i.e., a molecule produced by or found in living cells, e.g., a protein, a carbohydrate, a lipid, a phospholipid, a nucleic acid, etc.

For purposes of the present invention, the term “calibration profile” refers to one or more calibration curves based on light intensity or optical property data for one or more respective arrays of microstructures in which the microstructures of each array have the same shape and two or more different heights. In one embodiment of the present invention, a calibration profile may be based on intensity data for one or more respective arrays of iridescent microstructures in which the iridescent microstructures of each array have the same shape and two or more different heights. The calibration curves and calibration profile may be adjusted based on the differences between the measured heights of the iridescent microstructures of the arrays of the calibration standard and the heights determined from the calibration determined solely by the scattered light intensities detected by a camera, including detection at different exposure conditions, such as exposure time, lamp intensities, light path adjustments, hardware and/or software gain, etc., for the iridescent microstructures of the arrays of the calibration standard. In another embodiment of the present invention, the calibration profile may be based on intensity data for one or more respective arrays of iridescent microstructures in which the iridescent microstructures of each array have the same shape and two or more different heights. The calibration curves and calibration profile may be adjusted based on the differences between the measured heights of the iridescent microstructures of the arrays of the calibration standard and the heights determined from the calibration determined solely by the intensities of scattered light detected by a camera, including detection at different exposure conditions, such as exposure time, lamp intensities, light path adjustments, hardware and/or software gain, etc., for the iridescent microstructures of the arrays of the calibration standard. Within an array of microstructures that is used to obtain a calibration profile, two or more microstructures may have the same height.

For purposes of the present invention, the term “camera” refers to any type of camera or other device that senses light intensity. Examples of cameras include digital cameras, scanners, charged-coupled devices, complementary metal oxide semiconductor (CMOS) sensors, photomultiplier tubes, analog cameras such as film cameras, etc. A camera may include additional lenses and filters, such as the lenses of a microscope apparatus that may be adjusted when the camera is calibrated.

For purposes of the present invention, the term “dehydrated lipid multilayer grating” refers to a lipid multilayer grating that is sufficiently low in water content that it is no longer in fluid phase.

For purposes of the present invention, the term “detector” refers to any type of device that detects or measures light. A camera is a type of detector.

For purposes of the present invention, the term “dot” refers to a microstructure that has a zero-dimensional shape.

For purposes of the present invention, the term “fluid” refers to a liquid, gel or a gas. A fluid may be a pure fluid, a mixture of fluids, a suspension, a solution, etc.

For purposes of the present invention, the term “fluid droplet” refers to a droplet of a fluid.

For purposes of the present invention, the term “freezing by dehydration” refers to removal of residual water content, for instance by incubation in an atmosphere with low water content, for instance a vacuum (<50 mbar) or at relative humidity below 40% (at standard temperature and pressure).

For purposes of the present invention, the term “grating” refers to an array of dots, lines or two-dimensional shapes that are regularly spaced at a distance which causes coherent scattering of incident light.

For purposes of the present invention, the term “hardware and/or software” refers to functions that may be performed by digital software or digital hardware, or a combination of both digital hardware and digital software.

For purposes of the present invention, the term “height” refers to the maximum thickness of the microstructure on a substrate, i.e., the maximum distance the microstructure projects above the substrate on which it is located.

For purposes of the present invention, the term “interface region” refers to a region where an object, such as a cell, a fluid droplet, etc., interacts with an iridescent surface. An interface region comprises parts of both the object and iridescent surface that are in contact with each other.

For purposes of the present invention, the term “iridescent” refers to any structure that scatters light.

For purposes of the present invention, the term “iridescent microstructure” refers to a microstructure that is iridescent.

For purposes of the present invention, the term “iridescent nanostructure” refers to a nanostructure that is iridescent.

For purposes of the present invention, the term “iridescent surface” refers to a surface that is iridescent. Examples of iridescent surfaces include lipid multilayer gratings, butterfly wings, etc.

For purposes of the present invention, the term “light,” unless specified otherwise, refers to any type of electromagnetic radiation. Although, in the embodiments described below, the light that is incident on the gratings is visible light, the light that is incident on a grating of the present invention may be any type of electromagnetic radiation, including infrared light, ultraviolet light, etc., that may be scattered by a grating. Although, in the embodiments described below, the light that is scattered from the gratings and detected by a detector is visible light, the light that is scattered by a grating of the present invention and detected by a detector of the present invention may be any type of electromagnetic radiation, including infrared light, ultraviolet light, etc., that may be scattered by a grating.

For purposes of the present invention, the term “light source” refers to a source of incident light that is scattered by a grating of the present invention. In one embodiment of the present invention, a light source may be part of a device of the present invention. In one embodiment of the present invention, a light source may be light present in the environment of a grating of the present invention. For example, in one embodiment of the present invention, a light source may be part of a device that is separate from the device that includes the detector of the present invention. A light source may even be the ambient light of a room in which a grating of the present invention is located. Examples of a light source include a laser, a light-emitting diode (LED), an incandescent light bulb, a compact fluorescent light bulb, a fluorescent light bulb, etc.

For purposes of the present invention, the term “line” refers to a “line” as this term is commonly used in the field of nanolithography to refer to a one-dimensional shape.

For purposes of the present invention, the term “lipid multilayer” refers to a lipid coating that is thicker than one molecule.

For purposes of the present invention, the term “lipid multilayer grating” refers to a grating comprised of lipid multilayers.

For purposes of the present invention, the term “low humidity atmosphere” refers to an atmosphere having a relative humidity of less than 40%.

For purposes of the present invention, the term “mechanotransduction” refers to the various mechanisms by which a cell converts mechanical stimulus into chemical activity.

For purposes of the present invention, the term “microfabrication” refers to the design and/or manufacture of microstructures.

For purposes of the present invention, the term “microstructure” refers to a structure having at least one dimension smaller than 1 mm. A nanostructure is one type of microstructure.

For purposes of the present invention, the term “nanofabrication” refers to the design and/or manufacture of nanostructures.

For purposes of the present invention, the term “nanostructure” refers to a structure having at least one dimension on the nanoscale, i.e., a dimension between 0.1 and 100 nm.

For purposes of the present invention, the term “plurality” refers to two or more. Therefore, an array of microstructures having a “plurality of heights” is an array of microstructures having two or more heights. However, some of the microstructures in an array having a plurality of heights may have the same height.

For purposes of the present invention, the term “scattering” and the term “light scattering” refer to the scattering of light by deflection of one or more light rays from a straight path due to the interaction of light with a grating. One type of interaction of light with a grating that results in scattering is diffraction.

For purposes of the present invention, the term “white light” refers to visible light.

### Description

The physicist Richard Feynman once said about physical theories, “What I cannot create, I do not understand.” The same could be said about biology, as purely biological systems are highly complex and cannot be completely understood by observation alone. The use of synthetic biomaterials, such as surfaces and model cells, can be used to identify which biological functions and behaviors can be reproduced using artificial models and which ones cannot. That approach, in combination with observation of natural systems, makes it possible to test biophysical hypotheses in a way that cannot be directly achieved using purely biological systems.

In one embodiment, the present invention uses nanofabrication to provide multifunctional biomaterial surfaces and model cellular systems that allow investigation of the physicochemical basis for cell adhesion and mechanotransduction while providing a novel, label-free optical diffraction-based readout system.

Topographically and chemically structured biomaterial interfaces (both natural and artificial) are well known to exhibit properties that can be dramatically different from those of smooth, homogeneous surfaces formed from the same material. For example, an interface that is periodically structured on the scale of optical wavelengths (˜0.1-5 μm) can exhibit photonic properties that differ from those of the homogeneous bulk material; the simplest example is a diffraction grating.¹ Similarly, the wetting or adhesive properties of a surface are strongly affected by topography at a variety of scales (˜10 nm-10 μm).² Finally, the interaction of cells with structures of subcellular (<10 μm) dimensions affects cellular behavior by a combination of both specific molecular signaling pathways and mechanical transduction mechanisms.²⁻³ In some embodiments of the present invention, multifunctional biomaterial surfaces may be structured at the subcellular scale where these three phenomena converge to provide novel understanding of the fundamental physical, chemical and biological mechanisms that govern cell-surface interactions.

The basic understanding of the cell-biomaterial interface provided by embodiments of the present invention may be used to guide the rational design and engineering of biomaterial surface textures and rapid in vitro assays for testing their function. Techniques of the present invention may be of use in a wide range of scientific and industrial fields, such as host-microbe interactions, biofouling remediation, tissue engineering, wound healing and synthetic biology, to name a few. The low cost of the materials employed may allow the techniques of the present invention to be widely used, for instance in third world and developing countries.

The microscopic and nanoscopic textures of a surface are known to influence the morphology and behavior of adherent biological cells through contact guidance.⁴ In recent decades, microfabrication methods developed initially for microelectronics applications have been applied to the study of cell-surface interactions. Improvements in the resolution of lithographic methods have led to the capability of generating surfaces with features of subcellular dimensions, i.e., well below 10 μm, using a variety of lithographic techniques.⁵⁻⁷ The patterning methods can be generally divided into two types: topographical and patterning.⁸ Such subcellular features have repeatedly demonstrated significant effects on a variety of cell responses such as adhesion, signalling, elongation, migration, proliferation, differentiation and death.^{3,9-18} A wealth of data has been published on the topic of cells cultured on a wide variety of patterned surfaces,¹⁹ but the mechanisms by which subcellular features affect cellular function remain unclear. Also lacking is a reliably predictive relationship between the surface pattern geometry and the biological effect, although a few recent studies (including one by Lenhert et al.) seek to achieve this challenging yet worthwhile goal.^{2,20-21}

In one embodiment, the present invention provides structured surfaces by a combination of top-down and bottom-up fabrication methods in order to achieve high resolution, high throughput and multifunctionality at a reasonable cost:throughput ratio for quantitative cell-culture screening.

In one embodiment, the present invention provides the systematic characterization of the topography, anisotropic wettability and iridescence of the surfaces in order to examine the correlation of physicochemical properties to cell responses, as well as to provide a novel rapid optical readout system.

In one embodiment, the present invention provides test model systems based on multicomponent phospholipid vesicles and adherent lipid multilayers as synthetic lipid-based biomaterials capable of mimicking, predicting and ultimately providing insights into the supramolecular mechanisms behind cell-surface interactions.

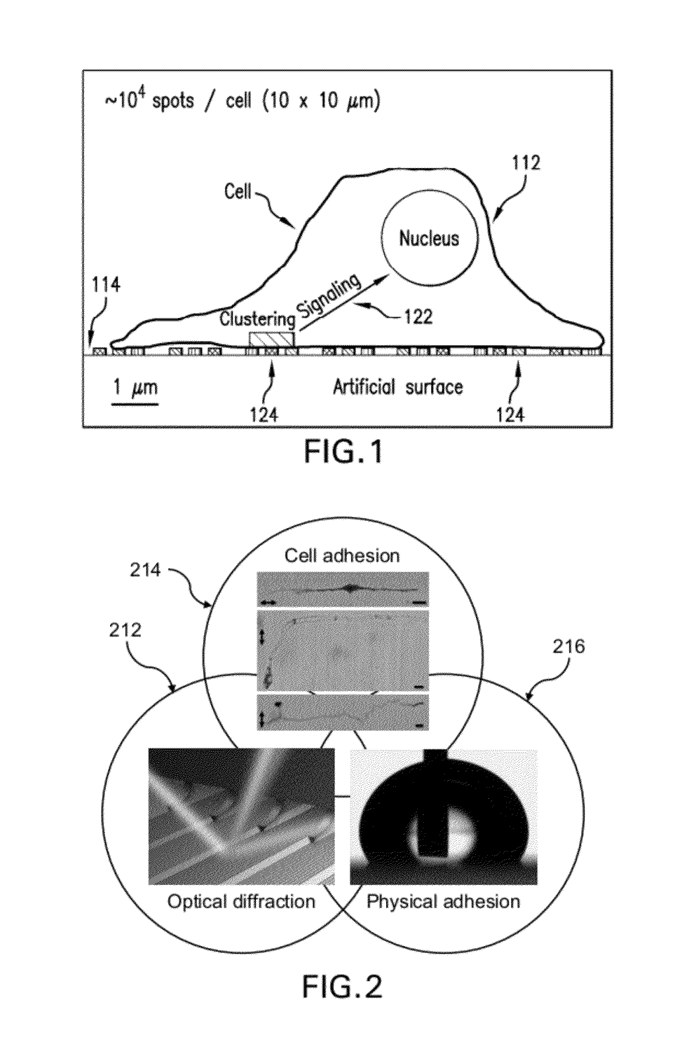

A major challenge in the field of cell culture on nanolithographically structured surfaces is that the number of possible subcellular patterns that could theoretically be fabricated is far greater than the number that can be practically tested, due to the cost and practical challenges in controlled testing of each pattern. FIG. 1 illustrates the complexity of the relationship between surface geometry and cell behavior. FIG. 1 shows a combinatorial calculation of the number of possible subcellular patterns in the case of multimaterial chemical patterning, with a lateral resolution of 100 nm. If n is the number of materials, there are ˜(n+1)^{10,000} possible pattern combinations on the area of one cell 112 on an artificial surface 114. As a purely heuristic screen on that scale is impossible, an understanding of the mechanisms involved in cellular pattern recognition is necessary.

Consider the number of possible patterns that one could draw with a technique such as multiplexed DPN.²² With phospholipids as inks, this method has a lateral resolution of ˜100 nm and allows the integration of multiple ink functionalities. A simple combinatorial calculation, without consideration of symmetry, reveals that about (n+1)^{10,000} different patterns could be drawn, where n is the number of materials used. Although the vast majority of studies simplifies this problem by drawing regular dot arrays or line arrays with varying pitch, such a reductionist approach is limited in its ability to unravel the complex hierarchical structure-function relationships involved in cell-surface interactions.

Geometry-specific contact guidance effects, where micro- or nanostructures on a surface induce specific and controllable cell responses, are of particular interest for biomaterial surface engineering as well as elucidation of cell function in vivo. Several hypotheses have been put forth to explain the effects of cell response to patterned surfaces, somewhat specific to the particular function in question. For example, length scales of ˜58-73 nm in the spacing of integrin-binding ligands on a surface have been found to be critical in initiating signalling pathway involved in cell adhesion (as shown in FIG. 1).^{6,12-13,29-36} Significant evidence also supports the role of membrane topography and its relation to such clustering-based signalling events and membrane protein function in general.³⁷⁻⁴⁰ Clustering-dependant signalling events are shown in FIG. 1 by arrow 122. Membrane proteins and associated clustering molecules (such as focal adhesion proteins) are shown by rectangles 124. In this mechanism, bending of the membrane due to a particular topographical feature affects the function of signalling-related-membrane-bound proteins and lipid raft formation, thus transducing the surface signal into particular cell behavior. Cellular appendages such as filopodia and lamellipodia are also known to play roles in surface texture detection.⁴¹⁻⁴⁵ Another general signal transduction pathway is mechanotransduction, through which mechanical forces acting upon a cell are converted into biochemical signals that affect processes such as gene expression.^{29,46-47} One mechanotransduction concept is that the cytoskeleton amplifies mechanical forces by means of a tensegrity network, which applies mechanical forces capable of mechanically deforming the nucleus and thus affecting its function.^{34-35,48}

In order to distinguish specific and active signal transduction mechanisms based on the biomolecular machinery that is characteristic of living systems from less specific and more passive contact guidance mechanisms, the state-of-the-art lithography and model systems may be to test the hypothesis of capillary-induced contact guidance.² Although such a hypothesis was originally put forth by Weiss to explain directed neuronal outgrowth,⁴⁹⁻⁵⁰ suitable methods for properly testing it have, so far, been lacking. This hypothesis draws upon the well-established yet still rapidly evolving physicochemical field of adhesion.⁵¹⁻⁵² Physical approaches to adhesion have historically taken a strictly reductionist approach by using pure liquids and as clean and smooth surfaces as possible to define and measure interfacial energies precisely. The majority of theoretical explanations developed from this reductionist approach, however, are not sufficient to explain cell adhesion because cell surfaces are highly heterogeneous and dynamically changing, precluding definition of an interfacial energy, as can be done for pure liquid droplets.^{36,51 55-56} Developing better experimental methods has so far been limited for three reasons: 1. surface structures of subcellular feature size are still being developed and characterized, and in many cases they have been prohibitively expensive for the statistical approach necessary for cell culture; 2. sessile liquid droplets used to characterize surface are typically macroscopic, despite significant evidence that as sessile droplets decrease in size their wetting properties change;⁵⁷ and 3. heterogeneous and dynamic model systems such as vesicles or multicomponent liquids have only recently gained attention.⁵⁸⁻⁶⁰ In one embodiment, the present invention uses capillary and optical theories to design surfaces that wet anisotropically²³⁻²⁵ and diffract light.^{1,26-28}

Although this problem is at least a century old and still unsolved, recent scientific trends towards biologically inspired materials and complexity, as well as advances in nanofabrication, now enable us to overcome these limitations. For example, arbitrary surface structures covering large areas can now be rapidly and cheaply structured by means of massively parallel DPN, nanoimprinting and soft lithography. Contributions to these developments have been made by Lenhert and Nafday.^{2-3,61-75} Efforts at elucidating the adhesion of microscopic and nanoscopic liquid droplets, vesicles and supported lipid multilayers provide insights into the dynamic processes of cell-sized droplets adherent on surfaces.^{57,76-79} Significant interest has developed in the dynamic wetting properties of both chemically and topographically nanostructured surfaces.^{2,24-25,80} For example, interactions of complex liquid mixtures with surfaces can result in reactive wetting and dewetting or may lead to running droplets and vesicles capable of mimicking certain aspects of cell migration, in minimal synthetic systems.^{69,81} Effects observed during these efforts make it clear that much remains to be learned about even simple synthetic liquid mixtures and structured surfaces at the scale of cells, and that understanding these effects could provide insights into the physical principles that govern the adhesion of living cells.

Surfaces structured with periodic topographies can give rise to optical diffraction when illuminated at the appropriate angle (illustrated in circle 212 of FIG. 2). Although grooved topographies or gratings structured at visible wavelengths are common substrates for cell culture, their diffractive properties to observe cell-surface interactions have only rarely been used.⁸²⁻⁸⁹ In one embodiment, the present invention uses this type of surface for comparing cell adhesion (illustrated in circle 214 of FIG. 2) and liquid (physical) adhesion (illustrated in circle 216 of FIG. 2). In particular, the use of optical diffraction as an imaging method to monitor subcellular processes, or adhesion of liquid droplets appears to be unexplored in the literature, despite the potential to provide insights into the dynamics of adhesion. Simply illuminating these surfaces at the appropriate angle while imaging with an optical microscope can yield a variety of novel information about the interfacial structure in a label-free manner. For example, Lenhert has recently developed a novel class of biomaterial by constructing diffraction gratings out of supported phospholipid multilayers fabricated by direct-write DPN.¹

FIG. 2 illustrates how surface structuring with anisotropic gratings may be used to develop multifunctional surfaces that exhibit optical diffraction, anisotropic wetting and controllable cell adhesion. FIG. 2 shows overlap in material functionality based on optical properties, physical adhesion and cell adhesion. Surfaces structured by grooves patterned on optical wavelengths may be characterized based on these three properties in order to develop multifunctional surfaces capable of rapidly testing biological hypotheses. Nanoimprinting and massively parallel DPN may allow the rapid and affordable mass production of specifically designed surface structures over areas large enough for cell culture. The adhesion properties of these surfaces may be characterized on larger scales by determining dynamic contact angles and on smaller scales by means of anisotropic spreading experiments with microscopic liquid droplets and model systems based on lipid vesicles and DPN-deposited lipid multilayers.^{66,90} Cell culture may be used to assay biocompatibility, and optical diffraction from the substrates may be monitored throughout the characterization processes in order to inform development of novel multifunctional materials that are capable of monitoring cell adhesion in a label-free manner and providing insights into the dynamics of initial cell adhesion which leads to mechanotransduction.

In one embodiment, the present invention provides structured surfaces by a combination of top-down and bottom-up fabrication methods in order to achieve high resolution, high-throughput and multifunctionality at a reasonable cost:throughput ratio for quantitative cell-culture screening. Embossing may be carried out as described previously.²⁻³ Subcellular chemical patterning may be carried out by bottom-up fabrication using multiplexed DPN to deliver multiple functional lipids to different areas of the substrate.^{22,64,66} This method may also be used for surface characterization through its use for the deposition of cell-sized droplets, or model systems.

Top-down lithography may be carried out with established resist patterning and etching protocols. Photolithography may be carried out to obtain gratings with pitch from 300 nm to 2 μm. Massively parallel DPN may be used for fabrication of large-area topographical gratings as well as for mask fabrication. DPN uses the tip of an atomic force microscope (AFM) as an ultrasharp pen to deliver materials to a surface and is capable of being carried out in a massively parallel fashion, over square centimeter areas at low cost.^{66,75,91-92}

For topographical structuring, commercially available methods for patterning self-assembled monolayers on gold surfaces may first be used.⁷⁵ A thin gold film evaporated onto silicon [100] may be used as a substrate. Self-assembled monolayers of octadecane thiol may be patterned on the gold surfaces by massively parallel DPN. This monolayer then may be used as an etch resist for selective etching of the gold surface.⁹³ The gold is then, in turn, used as a resist against the anisotropic etching of the silicon [100] surface.⁹⁴

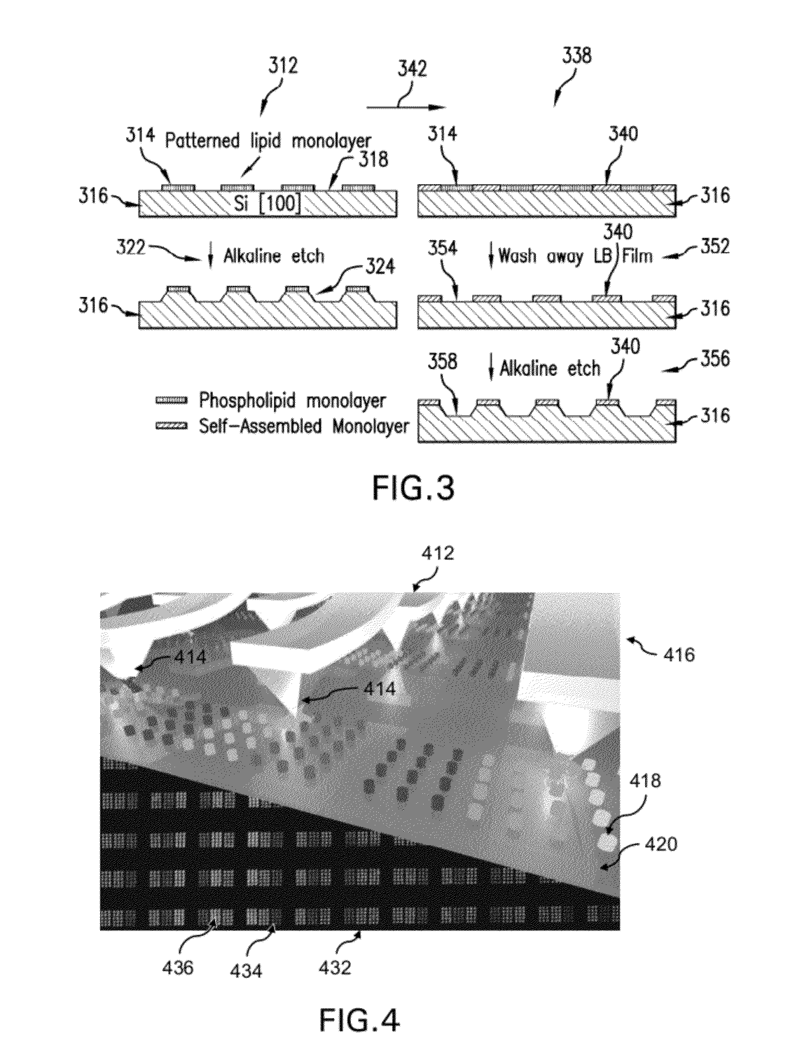

As the resolution of this etch process is limited by the thickness of the gold film (typically about 50 nm), it is possible to use DPN-patterned supported phospholipid monolayers, bilayers and multilayers and templated self-assembled silane monolayers on silicon [100] as direct etch resists as shown in FIG. 3 and described in a preliminary work in which Langmuir-Blodgett (LB) lithography was used to make chemically striped surfaces.^{70,95} Surface-supported lipid monolayers formed by the LB technique developed as a resist against alkaline etching of silicon [100] are described by Lenhert et al.⁷⁰ The surfaces structured by this lithographic approach may be characterized by atomic force microscopy (AFM) and scanning electron microscopy,⁷⁰ as well as by optical diffraction. FIG. 3 shows phospholipid monolayers as etch resists in process 312. Process 312 starts with a patterned lipid monolayer 314 on an Si [100] substrate 316. Patterned lipid monolayer 314 leaves exposed areas 318 that are etched with an alkaline etchant in alkaline etch step 322 to produce an etched surface 324. A second process shown in FIG. 3, i.e., process 338, also starts with patterned lipid monolayer 314 on Si [100] substrate 316. A self-assembled monolayer film 340 is deposited on patterned lipid monolayer 314 in step 342 to so that patterned lipid monolayer 314 and self-assembled monolayer film 340 are on an Si [100] substrate 316. Patterned lipid monolayer 314 is washed away in step 352 to leave exposed areas 354 having the pattern of patterned lipid monolayer 314. Exposed areas 354 are etched away with an alkaline etchant in alkaline etch step 356 to produce an etched surface 358.

These surfaces may then be used as templates for embossing of polystyrene surfaces and molding of polydimethylsiloxane (PDMS) as well as collagen gel surfaces. Embossing of polystyrene may be carried out as described previously.²⁻³ When polystyrene is put in contact with a master at temperatures beyond the glass transition of the polymer, the polymer will conform to the topography of the master. Upon cooling and lift-off, the polymer retains the topography of the master. The master can then be used repeatedly to mass-produce substrates. Previous work showed that both the molded polystyrene an the silicon master can be used for molding of elastomeric PDMS substrates.⁶⁸ In this process, a polymer precursor and a cross-linking agent are mixed together and allowed to cure on top of the master. The master is then removed, leaving the topographical structure on the surface.

Chemical patterns may also be fabricated by means of DPN. Because DPN is a constructive nanoarraying method, it is uniquely capable of integrating multiple materials in a bottom-up manner, a method referred to as multiplexed DPN.^{22,64,67} Smooth polymer surfaces replicated from unstructured surfaces, as well as the topographically structured surfaces, may be functionalized by different phospholipids. Lenhert has developed methods for the massively parallel and multiplexed patterning of phospholipids, as shown in FIG. 4. As the driving force for patterning of phospholipids is based on physical adhesion of the amphiphilic materials, a variety of surfaces including polymers such as polystyrene and PDMS can be patterned with this method. The combination of chemical and topographical patterning may be carried out through a systematic combinatorial screening approach.⁹⁶

FIG. 4 shows massively parallel and multiplexed DPN. Shown in a top portion 412 of FIG. 4 is a schematic drawing of different tips 414 in a parallel array 416 integrating different inks 418 on a surface 420. Shown in a bottom portion 432 of FIG. 4 is a fluorescence micrograph of phospholipid patterns 434 of dots 436 with a neighboring dot spacing of 2 microns.^{4,6,9}

In one embodiment, the present invention provides a method to characterize systematically the topography of anisotropic wettability and iridescence of the surfaces in order to examine the correlation of physicochemical properties to cell responses, as well as to provide a novel rapid optical readout system. Routine topographical measurements may be carried out by AFM. Topographical grating templates may be thoroughly characterized by high-resolution imaging of eight random areas/cm². The etch depth, ridge width, groove width and edge roughness of the masters may be quantitatively determined and correlated with the optical diffraction color and efficiency. Wettability measurements may be carried out by dynamic contact angle metrology, which takes the anisotropy of the surfaces into account.^{2-3,70} Replicated substrates may then also be characterized by AFM, dynamic contact angle metrology and optical diffraction. Once calibrated, the optical diffraction may be used as a quality-control indicator, with much higher throughput and cost-efficiency than AFM or other methods. Chemically patterned surfaces may be initially characterized by fluorescence microscopy for high-throughput quality control. For this purpose, fluorescently labeled lipids may be doped into the ink for observation by epifluorescence and confocal microscopy.

Topographically and chemically patterned surfaces are known to affect the adhesion of liquid droplets. Perhaps the best known example from nature is the surface of the lotus leaf, which produces a superhydrophobic and self-cleaning cuticle by means of micro- and nanoscopic topographical structures.⁹⁷ Since this property of the surface of the lotus leaf was discovered, a variety of other naturally occurring functional adhesive structures have been studied, inspiring development of synthetic topographical and chemical structures with controlled wettability.⁹⁸⁻¹⁰²

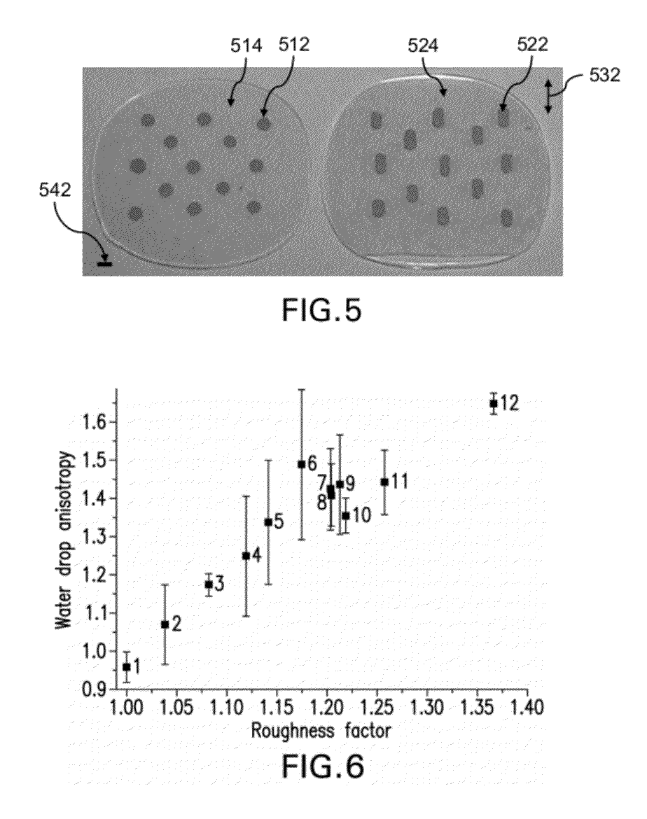

The wettability of a surface and shape of an adherent droplet is best described by the physical theory of adhesion and capillarity.⁵¹⁻⁵² The equilibrium contact angles for pure macroscopic droplets can be described by modifications to the basic Young equation by Wenzel and Cassie,¹⁰³⁻¹⁰⁶ and contact angle metrology provides a quantitative method for surface characterization. Measuring advancing and receding contact angles yields additional information about the heterogeneity of the surface that gives rise to contact angle hysteresis.⁵² On anisotropic surfaces, such as lipid multilayer gratings, this contact angle hysteresis is different in the directions parallel and perpendicular to the grooves, resulting in elongated droplet shapes.^{2,24-25} FIG. 5 shows anisotropic spreading of dye-containing water droplets 512 on a smooth control surface 514 and dye-containing water droplets 522 on a grooved surface 524. Double-headed arrow 532 shows the orientation of the grooves on grooved surface 524. Scale bar 542=1 mm.

The theory describing this effect on sinusoidally grooved surfaces based on capillary theory worked out analytically by Cox predicts a linear dependence on parameters that can be reduced to the roughness factor.¹⁰⁷ This linear dependence has been experimentally confirmed by Lenhert using topographically grooved polystyrene, as shown in FIG. 6. Using this quick method of surface characterization, Lenhert obtained quantitative values for the surface wetting anisotropy and found it to correlate significantly with cell alignment for both mammalian osteoblasts and hyphal fungi.² FIG. 6 shows water drop anisotropy plotted as a function of the roughness factor for 12 different groove topographies.²

Optical diffraction from surface relief gratings is a well-established phenomenon perhaps first described by Rittenhouse in 1786, and later developed for applications by Fraunhofer in 1824.¹⁰⁸⁻¹⁰⁹ The diffraction of light from gratings is described by the grating equation d(sin θₘ+sin θᵢ)=mλ, where d is the period of the grating; θₘ and θᵢ are the angles of diffraction maxima and incidence, respectively; m is the diffraction order; and λ is the wavelength of light. In addition to the angles and pitch of the grating, the grating height, shape and refractive index are also important factors in determining the intensity of light diffracted.²⁷ Lenhert has adapted bottom-up fabrication by means of DPN for the direct writing of multicomponent lipid multilayer gratings.¹ In this case, DPN is used constructively to deposit biofunctional lipid multilayers with controllable heights between ˜5 and 100 nm. DPN's high-resolution printing capabilities allow multiple materials to be simultaneously integrated into photonic structures on prestructured surfaces.

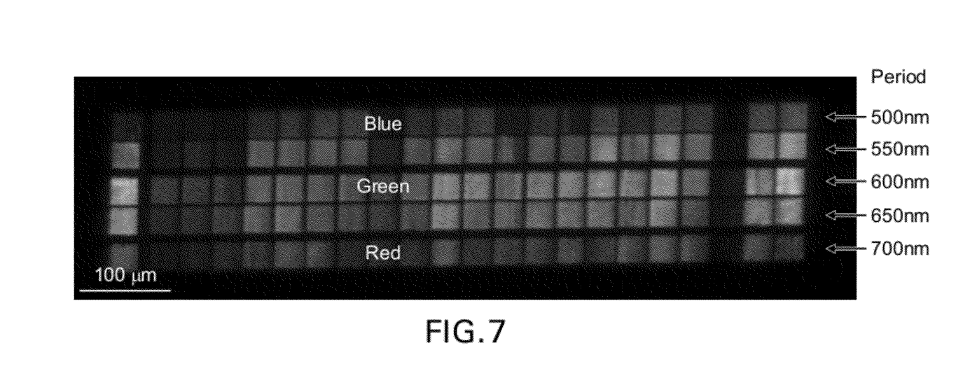

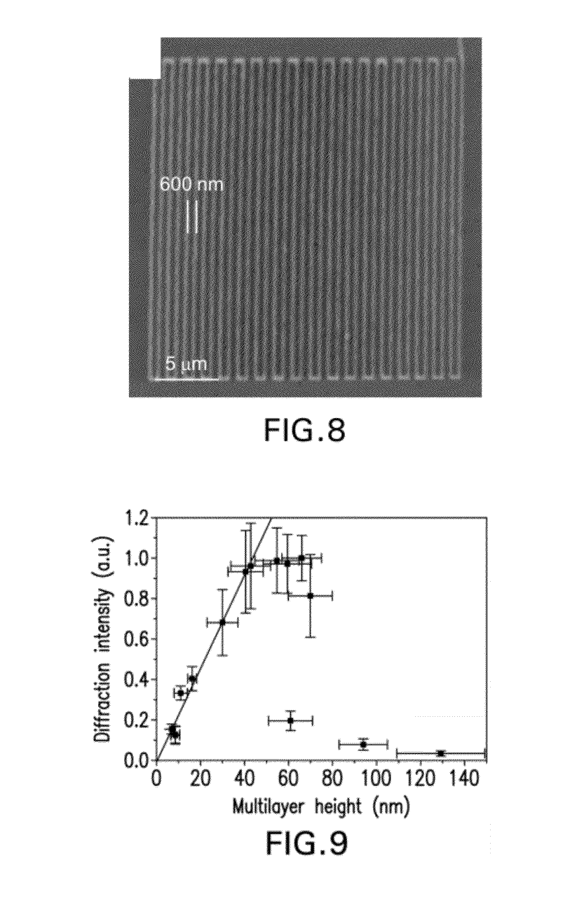

Gratings fabricated by both top-down and bottom-up lithographic methods may be characterized by monitoring of optical diffraction color and intensity and correlation of that information with the topographical information obtained by AFM measurements, as shown in FIGS. 7, 8 and 9 that show optical and topographical characterization of diffraction gratings. FIG. 7 is a micrograph of gratings of different pitch illuminated from ˜30° and observed through a microscope objective. FIG. 8 shows the AFM topography of a 600 nm grating. FIG. 9 shows a correlation of multilayer height to diffraction efficiency up to grating heights of 50 nm.¹

This calibration may be carried out for the polymer gratings as well as for lipid multilayer gratings. Because the optical diffraction is sensitive to the quality of a grating, these measurements provide another rapid measure of the surface quality. Once a semi-empirical relationship between the optical diffraction and the topography is established, further characterization may be carried out under liquid. Liquid droplets (aqueous and nonpolar) of different refractive indices may be used to calibrate the grating's response to immersion in, or exposure to, liquids. In addition to characterizing gratings under liquid, techniques of the present invention may be used to investigate the optical response of the gratings to adhesion of model systems including adherent droplets of different sizes, adherent lipid multilayers and vesicles, and adherent living cells, as described in the following sections.

In one embodiment, the present invention provides test model systems based on multicomponent phospholipid vesicles and adherent lipid multilayers as synthetic lipid-based biomaterials capable of mimicking, predicting and ultimately providing insights into the supramolecular mechanisms behind cell-surface interactions. Vesicles and microscopic liquid droplets may be used to recreate as much cell adhesion behavior as possible in synthetic systems.

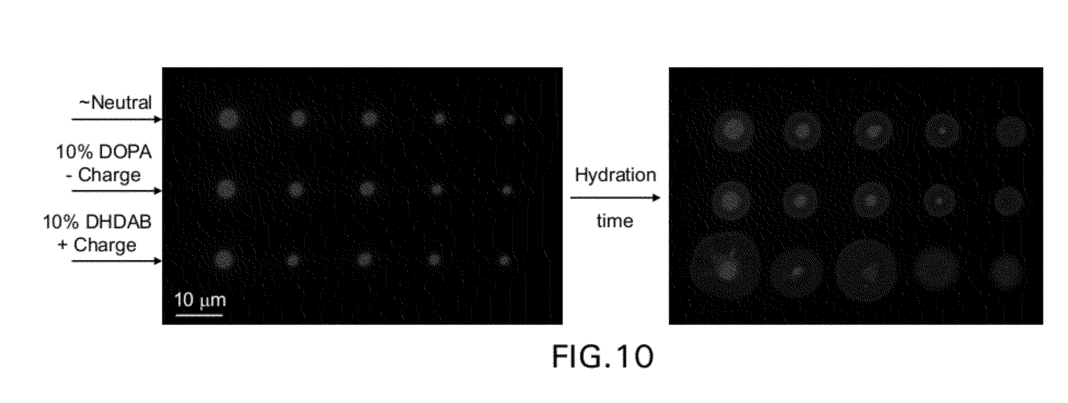

Microscopic droplets may be deposited by DPN, as shown in FIG. 10. FIG. 10 shows deposition and spreading of microscopic lipid droplets of three different lipid compositions, neutral, negatively charged and positively charged, printed on the same surface with DPN. Lipid spreading is observed by time-lapse fluorescence microscopy. The different droplets spread at different speeds, in this case depending on the charge of the lipid head group. Positively charged head groups spread significantly faster on plasma-oxidized glass than lipid mixtures with neutral (zwitterionic) or negatively charged head groups.

In one embodiment of the present invention, fluid phospholipid mixtures containing differently charged head groups may be deposited onto the same surface by multiplexed DPN. In contrast to an observable change in contact angle typical for spreading of bulk sessile droplets, lipid multilayers tend to spread as molecularly thin and homogeneous layers, as is the case for bilayers spread on hydrophilic surfaces and monolayers spread on hydrophobic surfaces.^{76-79,110} As the surface properties are known to have an influence on the spreading rate of phospholipids, this spreading may be used as a method of surface characterization. The spreading material is composed of the same biological lipids that give structure to cell membranes, and observation of the spreading rate as a function of lipid composition and solution composition allows quantitative characterization of the surfaces at the same scale as cells.

A fundamental difference between the surface or interfaces of living cells and that of pure liquid droplets or vesicles is that cell surfaces are highly heterogeneous and dynamically changing. For example, a wealth of evidence indicates that dynamic phase separation, partitioning and lipid raft formation in cell membranes is related to their function.¹¹¹⁻¹¹³ In order to investigate the roles of phase separation (and surface patterning in general), in some embodiments, the present invention uses surfaces chemically patterned by means of dip-pen nanolithography as well as phase-separated self-assembled monolayers⁷² and supported lipid bilayers to screen for adhesion of lipids composed of phase-separated lipid mixtures. A lipid raft mixture (POPC, cholesterol and sphingomyelin) may be used as a model system.¹¹⁴ Correlations between the characteristic lengths of phase separation and the adhesion to the surface may be examined. The use of model systems makes it possible to test the hypothesis that cells make use of phase-separated patterns in their cell membranes to modulate surface adhesion, an effect that has been demonstrated on larger scales with completely synthetic systems.¹¹⁵

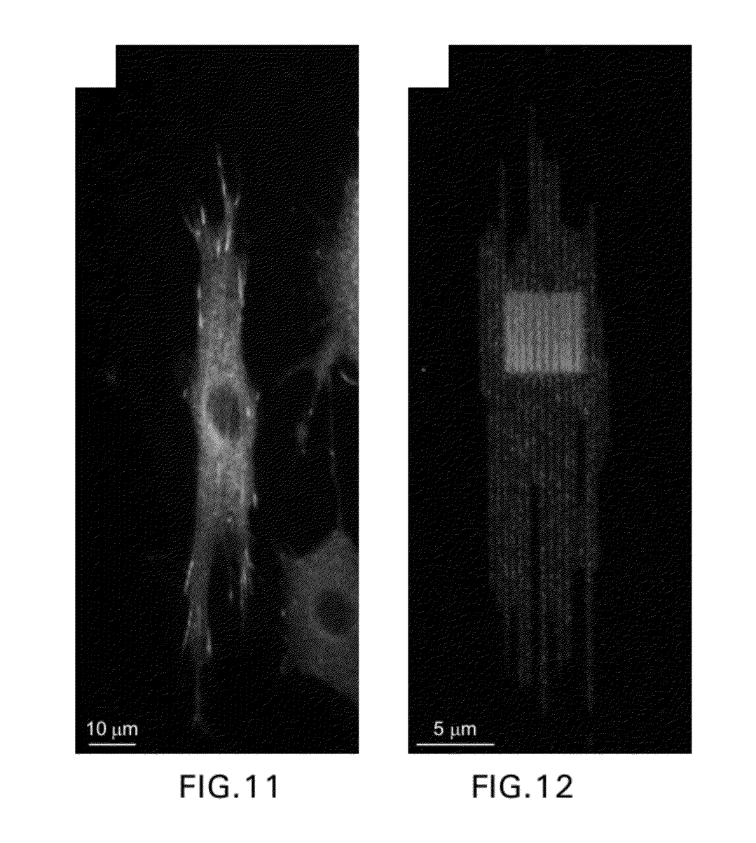

Printing of lipids onto prefabricated topographical relief gratings may be used as a method for characterizing the anisotropy of the surfaces. FIGS. 11 and 12 show a comparison of anisotropic cell spreading and anisotropic spreading of supported phospholipid multilayers on topographically grooved surfaces. For example, FIG. 11 shows a cell cultured on a grooved polystyrene grating surface,⁷⁰ and FIG. 12 shows a 5×5 μm phospholipid multilayer square on the same topography. FIG. 11 shows an osteoblast cell aligned with a grooved topography and stained for vinculin (a component in focal adhesions).⁵ FIG. 12 shows a supported phospholipid multilayer square with dimensions of topographical surface (grooved polystyrene), showing anisotropic spreading of comparable dimensions.

The anisotropic spreading of the phospholipids on microscopic scales may be correlated with the topographical and diffraction information obtained and compared to the behavior of living cells. Because the lipid spreading can be monitored in real time, dynamic information may be obtained. Furthermore, this approach may lead to novel methods for the structuring of optically diffractive and responsive lipid-based biomaterials.

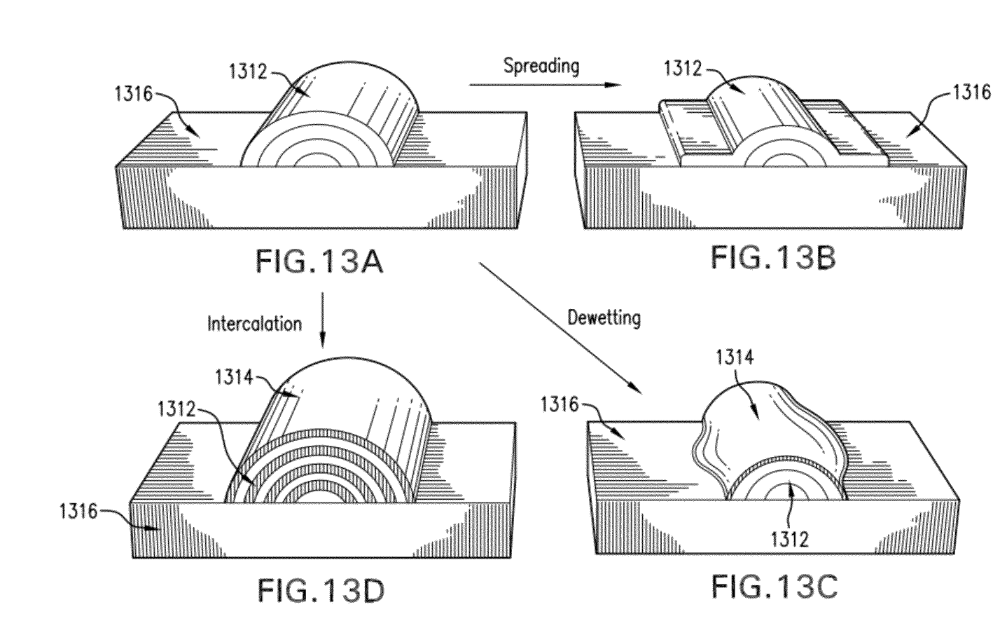

Lenhert has recently shown that protein interactions with lipid multilayers structured as diffraction gratings can be observed by monitoring optical diffraction as shown in FIGS. 13, 14, 15, 16, 17 and 18. The lipid multilayer gratings change size and shape upon protein binding and resulting changes in their adhesion to the surface. This leads to a change in optical diffraction, which can be monitored in a label-free manner. FIG. 13 shows a schematic sketch of three changes that have been observed.

FIGS. 13, 14, 15, 16, 17 and 18 show optical diffraction as a rapid, label-free measure of the effect of protein interactions with adhesion of model cellular systems. FIG. 13 shows schematic drawings of three effects observed as a result of lipid adhesion to the substrate and interactions with proteins in solution. The structuring of lipids into photonic structures provides a label-free method of observing dynamic structural changes in the lipid multilayer morphologies. These changes may be understood in terms of liquid adhesion to a solid surface where the lipid multilayers are, essentially, structured microscopic and nanoscopic oil droplets adherent on a surface. Three examples of shape changes are spreading, dewetting and intercalation of materials into the multilayer structure, as schematically illustrated in FIG. 13. In FIG. 13, lipid layers are indicated by reference number 1312, protein layers by reference number 1314, and a substrate by reference number 1316. FIG. 13A shows lipid layers 1312 deposited as a multilayer on substrate 1316. FIG. 13B shows spreading of lipid layers 1312 on substrate 1316. FIG. 13C shows dewetting of lipid layers 1312 with a covering of a protein layer 1314. FIG. 13D shows intercalation of protein layers 1314 with lipid layers 1312.

The drawings A, B, C and D of FIG. 13 have been sketched to reflect the well-documented tendency for hydrated phospholipid multilayers to stack on surfaces into ordered multilamellar bilayer stacks and for hydrophilic materials, such as proteins, to intercalate themselves between the hydrophobic multilayer sheets.

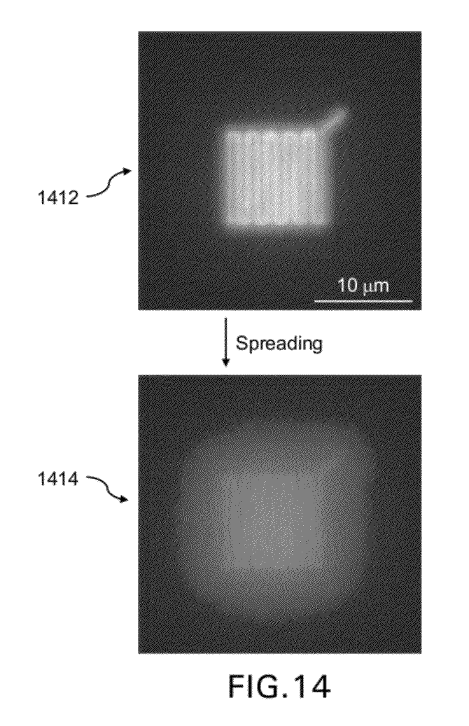

When patterned on surfaces, lipid multilayers are known to spread spontaneously in aqueous solution to form lipid bilayer or monolayer precursor films on certain substrates; see Lenhert, S., Sun, P., Wang, Y. H., Fuchs, H. & Mirkin, C. A., Massively parallel dip-pen nanolithography of heterogeneous supported phospholipid multilayer patterns, Small 3, 71-75 (2007); Sanii, B. & Parikh, A. N., Surface-energy dependent spreading of lipid monolayers and bilayers, Soft Matter 3, 974-77 (2007); Nissen, J., Gritsch, S., Wiegand, G. & Radler, J. O., Wetting of phospholipid membranes on hydrophilic surfaces—concepts towards self-healing membranes, Eur. Phys. J. B 10,335-44 (1999); and Radler, J., Strey, H. & Sackmann, E., Phenomenology and kinetics of lipid bilayer spreading on hydrophilic surfaces, Langmuir 11, 4539-48 (1995), the entire contents and disclosures of which are incorporated herein by reference. In air, the phospholipid DOPC undergoes a hydration-induced gel-fluid phase transition at a relative humidity of 40%, as observed by humidity-controlled calorimetry and DPN; see Lenhert, S., Sun, P., Wang, Y. H., Fuchs, H. & Mirkin, C. A., Massively parallel dip-pen nanolithography of heterogeneous supported phospholipid multilayer patterns, Small 3, 71-75 (2007); Sanii, B. & Parikh, A. N., Surface-energy dependent spreading of lipid monolayers and bilayers, Soft Matter 3, 974-77 (2007); and Ulrich, A. S., Sami, M. & Watts, A., Hydration of DOPC bilayers by differential scanning calorimetry, BBA Biomembranes 1191, 225-30 (1994), the entire contents and disclosures of which are incorporated herein by reference. The multilayer gratings therefore remain stable for long-term storage at low humidity, but upon exposure to humidity higher than 40% in air, the multilayers become hydrated and fluid and therefore spread slowly on the surface. This spreading can be observed both by fluorescence microscopy as shown in FIG. 14 and as a decrease in the diffraction intensity irreversibly indicating the presence of water vapor above 40% humidity.

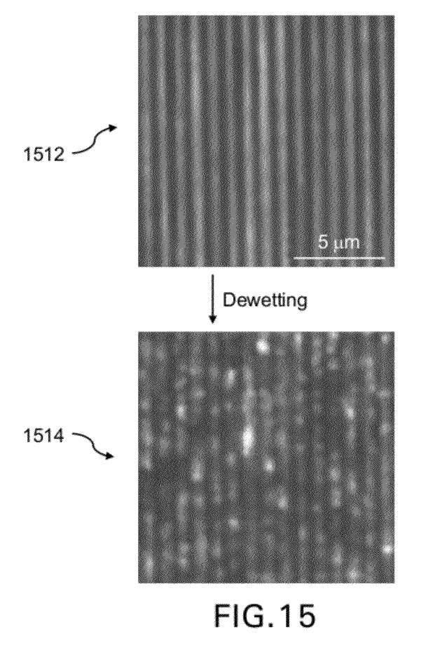

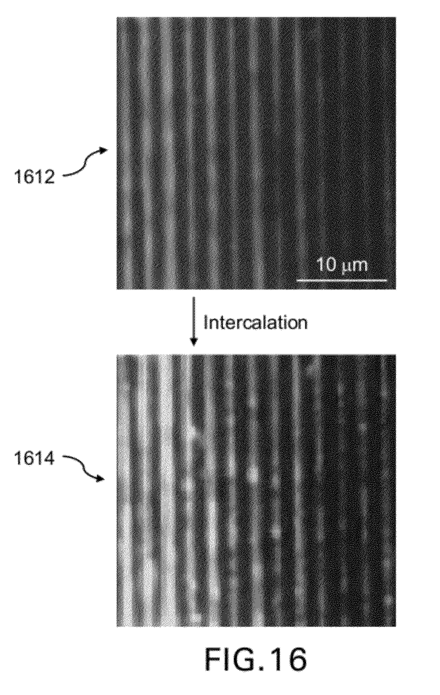

FIGS. 14, 15 and 16 show fluorescence micrographs of fluorescently labeled materials used to observe the dynamic processes. FIG. 14 shows lipid spreading in air, shown before exposure to humidity (image 1412) and after 5 minutes of exposure to humidity above 40% (image 1414). Surprisingly, lipid multilayer gratings can remain stable in an aqueous solution for at least several days when immersed under the appropriate conditions, permitting study of the structural changes upon binding of biological molecules such as proteins, which causes the dewetting and intercalation effects observed by fluorescence microscopy and shown in FIGS. 15 and 16. FIG. 15 is a fluorescence micrograph made with fluorescently labeled materials of dewetting of smooth lines of biotin-containing gratings under solution to form droplets after 1 minute of exposure to the protein streptavidin. FIG. 16 is a fluorescence micrograph made with fluorescently labeled materials of intercalation of protein into lipid multilayer grating lines of different heights after 1 hour of intercalation. FIG. 15 shows dewetting of smooth lines of biotin containing gratings under solution to form droplets before exposure to the protein streptavidin (image 1512) and after 1 minute of exposure to the protein streptavidin (image 1514). Top image 1612 of FIG. 16 is a fluorescence micrograph of fluorescein-labeled lipid grating lines before exposure to protein, and bottom image 1614 shows an overlaid fluorescence image of both fluorescence channels after binding of a Cy3-labeled protein to the layers.

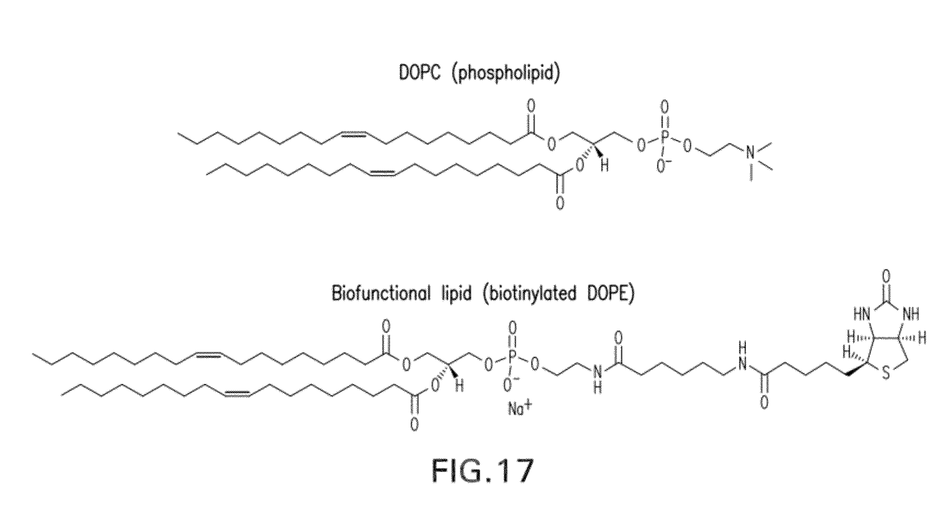

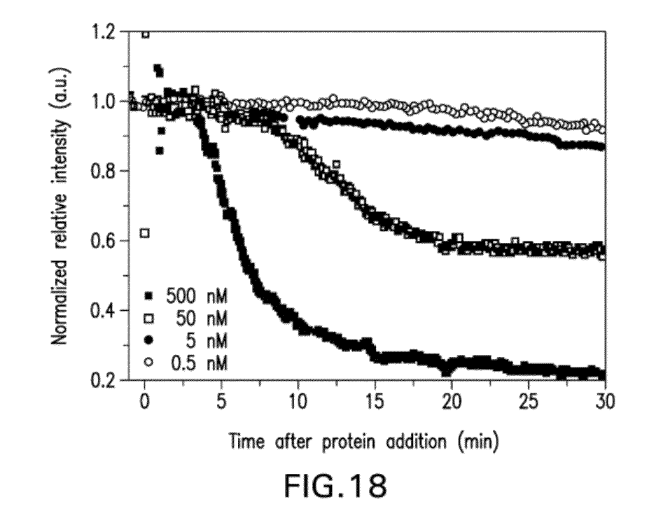

To observe the dewetting and intercalation effects using fluorescence microscopy, DOPC ink was doped with 5 mol % of a biotinylated lipid. FIG. 17 shows the chemical structures of phospholipids (DOPC and biotinylated DOPE) used as the DPN inks for fabricating biotinylated gratings for detection of the biotin-binding protein streptavidin, in parallel with control gratings composed of pure DOPC. FIG. 18 shows label-free detection of protein binding by monitoring of the diffraction from gratings upon exposure to protein at different concentrations. The decrease in diffraction intensity under these conditions is due to the dewetting mechanism.¹

The spreading and dewetting processes can be understood in terms of adhesion to the surface, whereas the intercalation mechanism results in an increased volume of the lipid multilayer grating elements. For example, the dewetting mechanism, or formation of droplets from a continuous line drawn on a surface by a pen, is a common practical method of characterizing surface energies by means of macroscopic dyne pens,¹¹⁶ and this method may be extended to the microscopic scales for use of biological lipids model cellular systems. Controlled dewetting from chemically patterned surfaces may also be used as a method for scaling up the functional lipid multilayer structures.¹¹⁷

The structuring of phospholipid multilayers on the wavelength of visible light provides a novel, rapid and label-free method of simulating cell membrane function. Comparable methods for fabricating the responsive lipid multilayer gratings may be developed by printing on prestructured surfaces such as the topographical relief gratings (as shown in FIG. 12) and by dewetting from chemically patterned surfaces.¹¹⁷ Further model systems may be investigated through the use of reconstituted integrin (including fluorescent fusion protein constructs provided by collaborator Michael Davidson) into the phospholipid multilayers. Upon exposure to protein, such as fibronectin which contains RGD sequences and binds to integrin to cause it to cluster, it may be possible to test the hypothesis that integrin clustering affects the surface tension (or membrane tension) in the model system. These model systems may provide a quantifiable link between the physicochemical characterization and the behavior of adherent living cells.

Although living cells are certainly far more complex and active molecular machines than these model systems, the dynamics of adhesion of microscopic lipid droplets is an active field with significant complexities of its own that are still far from being completely understood.¹¹⁸ Insights into the fundamental and complex physical laws that govern adhesion at scales larger than individual molecular complexes, yet smaller than bulk materials (i.e., the mesoscale), are being made by studying biological systems,¹¹⁹ and such understanding is necessary for the testing of biophysical hypotheses at the same scale.¹²⁰⁻¹²¹ Just as biomechanics at macroscopic scales cannot be understood without Newtonian physics, so the understanding of complex and dynamic capillary effects may provide insights into cell adhesion at microscopic scales.

Mechanotransduction is the biological process by which mechanical forces are transduced into signals.^{12,17,48,122-125} Although a significant amount of work has been done in this field, a fundamental question remains: How do cells detect surface topography? Several hypotheses have been advanced. One mechanism is based on membrane-bound signal transduction, for example, membrane curvature or tension-induced integrin clustering and focal adhesion formation.¹²⁶⁻¹²⁸ Another mechanism is based on the idea that cellular appendages such as lamellipodia and filopodia actively probe the surface, leading to a “decision” about cell polarity.⁴²⁻⁴³ Finally, the idea that geometric effects on, and force production by, the cytoskeleton are converted into biochemical signals has been proposed.³⁵

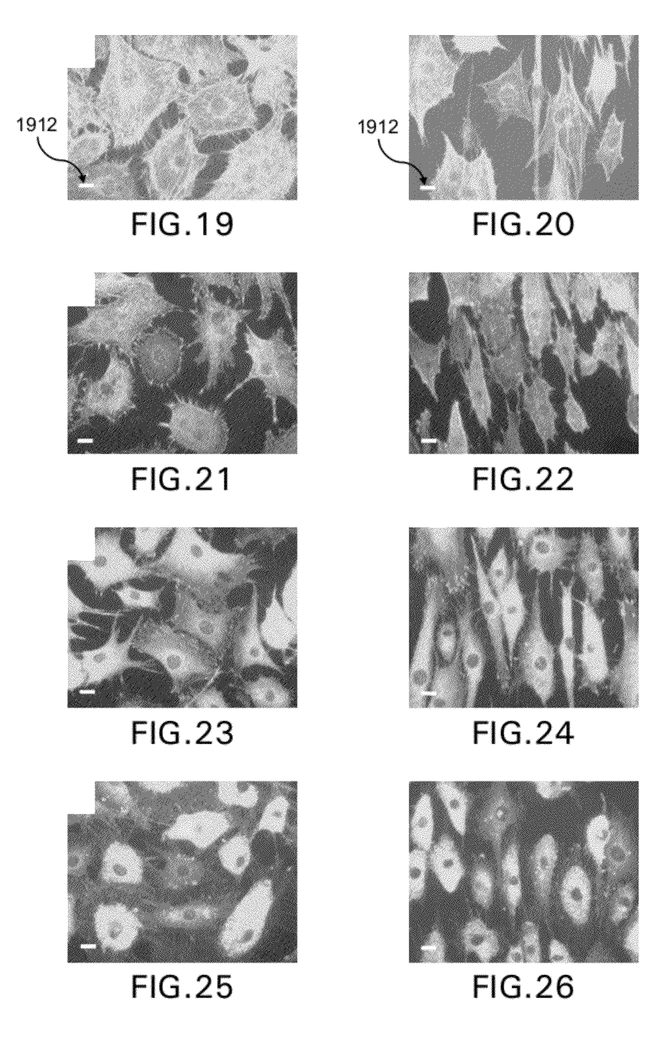

Lenhert has proposed and shown evidence from three different cell types that the physical capillary forces generated from the adhesion of any condensed matter to another provides an initial signal, which can be used to predict the shape of adherent cells as a function of surface geometry, with an example shown in FIGS. 19, 20, 21, 22, 23, 24, 25 and 26.^{2-3,70} FIGS. 19, 20, 21, 22, 23, 24, 25 and 26 are fluorescence micrographs of immunofluorescently labeled osteoblast cells on smooth polystyrene surfaces (FIGS. 19, 21, 23 and 25) and on polystyrene with 150 nm deep grooves at a pitch of 500 nm (FIGS. 20, 22, 24 and 26). Grooves are oriented vertically. Actin is labeled in FIGS. 19 and 20. Actinin is labeled in FIGS. 21 and 22. Inculin is labeled in FIGS. 23 and 24. Integrin (fibronectin receptor) is labeled in FIGS. 25 and 26. Bars 1912=10 μm. The staining indicates anisotropic formation of focal adhesions and stress fibers, which are proteins involved in mechanotransduction pathways.³

Such a perspective is consistent with all three of the hypotheses mentioned above, as well as observations that cell surface mechanics regulate cell shape in vivo.¹²⁰⁻¹²¹ This approach also provides a simple and quantitative method of predicting cell behavior as a function of surface geometry. Keller has also demonstrated substrate effects on cell morphology, adhesion and phenotype.¹²⁹⁻¹³²

In one embodiment of the present invention the ability of the surfaces to induce cell alignment and anisotropic migration, as well as cytoskeletal and focal adhesion localization, may be assayed by the in vitro culture of living cells. Embodiments of the present invention also involve examining the correlation between cell behavior, anisotropic wetting and the behavior of model systems while observing the optical diffraction from the substrates in real time. For this purpose, four different types of vertebrate cells may be investigated: rat aortic smooth muscle A7r5 cells, which can be induced to form a functional contractile apparatus; human U2OS osteosarcoma cells, which spread and adhere tightly to substrates though formation of both focal and fibrillar adhesions; human mesenchymal stem cells, which can be induced to differentiate into osteoblasts and deposit a Ca²⁺-mineralized matrix; and fish keratocytes, which move rapidly over substrates. The use of different cell types may make it possible to distinguish cell-specific effects from more general effects.

Extracellular matrix proteins such as collagen and fibronectin may be used to functionalize the surfaces after O₂ plasma treatment to provide RGD sequences which promote integrin-mediated cell adhesion, which may be compared to the model systems. Immunofluorescence may be used to observe cytoskeletal and adhesion-related proteins such as actin, α-actinin, vinculin (for focal adhesions), tensin (for fibrillar adhesions) and integrins, as shown in FIGS. 19, 20, 21, 22, 23, 24, 25 and 26.^{2-3,70} Motile cells form fibrillar adhesions through which they remodel the extracellular matrix.¹³³ The cytoskeletal inhibitors blebbistatin, which inhibits myosin II production of force in stress fibers, and nocodazole, which causes disassembly of microtubules, may be used to test the hypothesis that the cytoskeleton is involved in the production of force on the substrate that is necessary for stable adhesion and the initial determination of cell polarity on the surface.

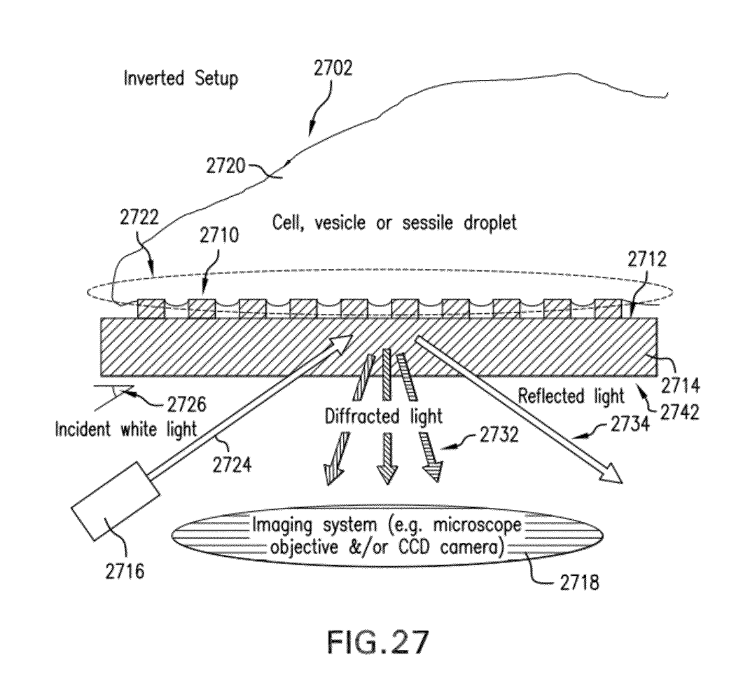

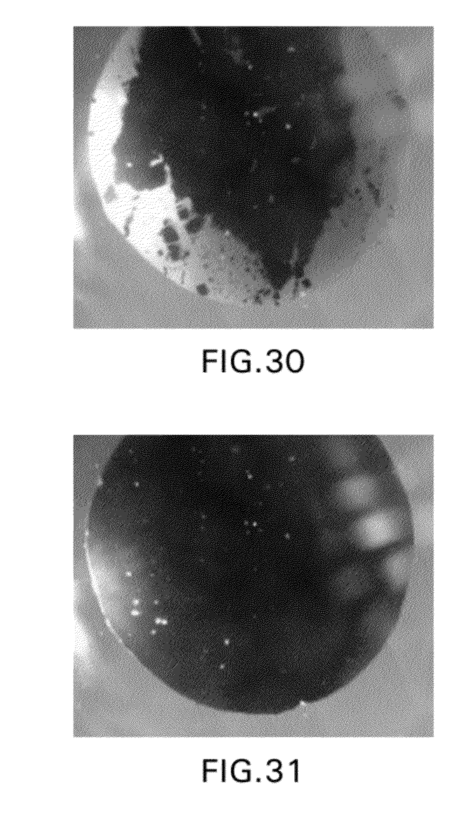

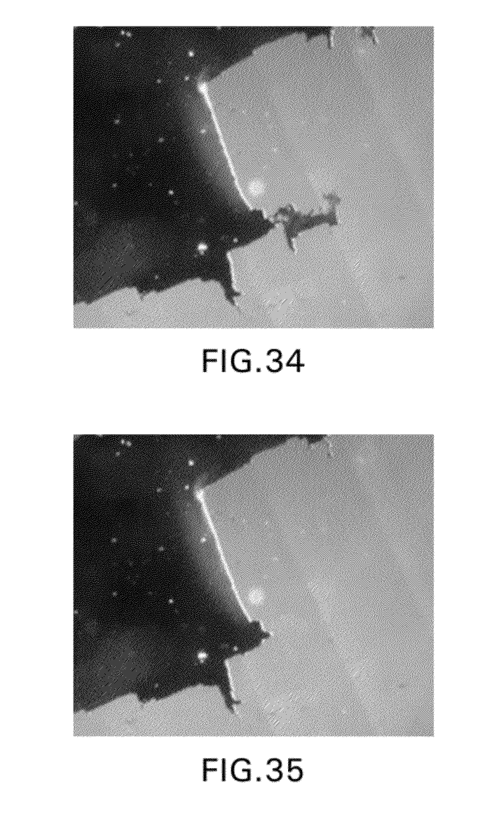

The adhesion of the cells to the different surfaces may be characterized by counting the cells attached to the surface per unit area and culture time. The contact area (and shape) of focal adhesions and fibrillar adhesions may be quantified by cell staining as well as from light diffracted from the gratings, as demonstrated in experiments shown in FIGS. 27, 28, 29, 30, 31, 32, 33, 34, 35, 36 and 37. Cell shape may be quantitatively analyzed with open source ImageJ software, and its correlation with the topographical dimensions as well as the shapes observed on the same surfaces by the model systems may be examined.²⁻³ Cell migration on the topographically functionalized surfaces may be assayed by a fencing approach employed previously.³ This approach is suitable for structured surfaces, as it does not require damaging them, and permits monitoring the migration of a proliferation front of a population of cells.

Work in the Keller lab (in collaboration with the lab of Joseph Schlenoff in the Florida State University Department of Chemistry and Biochemistry) has demonstrated that patterns of different chemistries and compliance dramatically influence response of the cells. Specifically, the A7r5 smooth muscle cells convert between a “synthetic” proliferative and motile phenotype, characterized by fibrillar adhesions, deficit of stress fibers and expression of “synthetic” marker proteins, and a “contractile” phenotype, characterized by focal adhesions, robust stress fibers and expression of “contractile” marker proteins depending on the properties of the surface.^{129-131,134} The phenotype of U2OS cells is likewise significantly influenced by substrate properties. On rigid surfaces, the U2OS cells spread well and establish robust ventral stress fibers attached at both ends to large vinculin-containing focal adhesions, whereas on more compliant surfaces, the cells become highly motile and establish podosomes¹²⁹⁻¹³¹ that secrete metalloproteinases. hMSCs deposit mineralized matrices differentially when cultured on different surfaces.

Those surface combinations found to induce a particular cellular response reproducibly may be scaled up so that enough cells can be collected for signal pathway analyses, especially of RhoA activity by Rhotekin assay and gene expression analysis by means of the microarray techniques. These signal pathway analyses may provide insights into pathways that are up- or down-regulated by the patterned and functionalized surfaces. Hypotheses can then be formed as to signal pathway and gene function in mechanotransduction, which can then be tested by the use of specific chemical inhibitors, such as y-27632 to inhibit RhoA activity and TAE66 to inhibit focal adhesion kinase activity, as well as by RNAi knockdown of specific proteins such as RhoA.

Although scattering from structured surfaces is typically viewed as a disadvantage for imaging these surfaces, in one embodiment, the present invention employs a diffraction for the rapid characterization of the biomaterial interface. In one embodiment, the present invention provides an apparatus and method for measuring adhesion of an object to a surface using iridescent surfaces and multi-angle illumination. An iridescent surface is illuminated by light (visible or other wavelengths detectible by a detector array, e.g., broad white light and/or monochromatic light) at particular incident angles. A detector such as a camera is used to detect an image of the illuminated area of the surface. An adhesive material is then placed on the surface, and the change in the scattered light detected by the camera by each pixel corresponding to a particular part of the surface is measured. The area of adhesion is then determined by analysis of the change in intensity detected for the various wavelengths detected. Changing the angle of the incident can then give further information, such as how deeply an adhesive material penetrates into the recesses of a topographically structured iridescent surface.

Although in one embodiment of the present invention, the detector is oriented at right angle, i.e., 90° with respect to the iridescent surface, in other embodiments of the present invention, the detector may be at other angles.

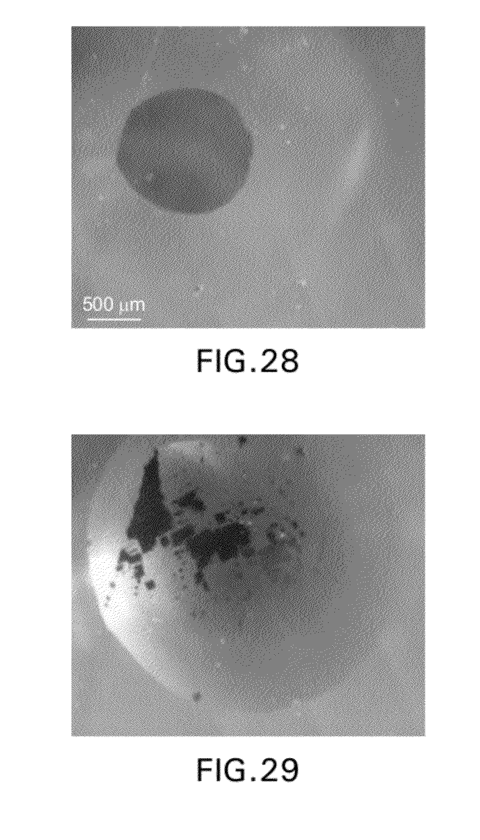

An inverted setup that may be used to determine the adhesion of an object to an iridescent surface is shown in FIG. 27, where the iridescent surface is illuminated at an angle through the transparent polymer substrate, while the diffracted light is imaged by an optical microscope. Systematic calibration of the optical diffraction with liquids of known refractive index as well as in contact with model systems as described earlier may provide a means of quantifying cell penetration into the grooves. FIG. 28 shows an experiment in which the dynamics of wetting and dewetting can be observed using this method with a simple model system (a sessile water droplet).

FIG. 27 shows a monitoring apparatus that may be used to observe adherent liquids, model systems and cells on an iridescent surface. FIGS. 28, 29, 30, 31, 32, 33, 34 and 35 show optical diffraction images of adherent liquids and cells obtained using the apparatus of FIG. 27.

FIG. 27 shows an apparatus 2702 according to one embodiment of the present invention comprising an iridescent surface 2710 on a side 2712 of a transparent or translucent substrate 2714, a light source 2716 and an imaging system 2718. An object 2720 to be examined is deposited on iridescent surface 2710. Object 2720 and iridescent surface 2710 interact in an interface region 2722. Incident light 2724 from light source 2716 is directed at an angle 2726 with respect to iridescent surface 2710 and passes through transparent or translucent substrate 2714 to be diffracted and reflected by interface region 2722 as diffracted light 2732 and reflected light 2734, respectively. Diffracted light 2732 is detected by imaging system 2718. In passing through transparent or translucent substrate 2714, light source 2716 passes through a side 2742 of substrate 2714 that is opposite to side 2712 of substrate 2714.

Although only one incident angle is shown in FIG. 27, the light source may be adjusted so that the incident light is directed at the iridescent surface at a variety of angles so that the imaging system can detect diffracted light from incident light at multiple angles. Based on the detected diffracted light from the light at multiple incident angles, the adhesion of the object to the iridescent surface may be determined by analysis of the change in intensity detected by the imaging system (detector) for the various wavelengths detected in the scattered light.

The iridescent surface of FIG. 27 may be formed by a lipid multilayer grating, a topographically structured surface such as a diffraction grating (possibly formed from a variety of materials such as polystyrene, polydimethylsiloxane, silicon, glass, etc.), other periodic or non-periodic topographies (including various scattering topographies such as small bumps on the surface), a thin film that is iridescent due to thin film interference, etc.

As shown in FIG. 27, according to one embodiment of the present invention, the object that is examined using the apparatus of FIG. 27 may be a cell, a vesicle or a sessile droplet of a fluid. However, other objects such as biofilms, adhesive tapes, inks, etc. may also be examined using the apparatus of FIG. 27.

The imaging system may be any type of detector such as a microscope, an objective camera, a charge-coupled device (CCD) camera, etc., or a combination of detectors.

Although the incident light in FIG. 27 is shown as being white light, other types of light may also be used as incident light.

The monitoring apparatus shown in FIG. 27 is an inverted-type monitoring apparatus because the light passes through the substrate prior to being diffracted by the iridescent surface.

The substrate of FIG. 27 may be virtually any type of transparent or translucent substrate on which lipid multilayer gratings may be deposited or grown or on which an iridescent material may be placed. Such substrates include materials such as glass, plastic, etc.

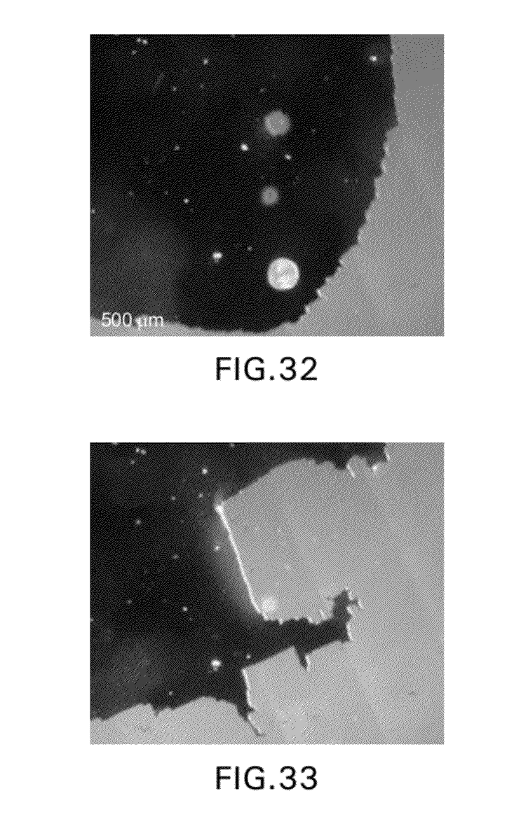

FIGS. 28, 29, 30 and 31 are time-lapse micrographs showing a water droplet being placed on an iridescent, molded PDMS surface using this setup. FIGS. 32, 33, 34 and 35 show a droplet dewetting from the surface. The dynamics of how the liquid interface follows the surface topography can be observed by watching the darkening (or change in efficiency) of the iridescence. Bar 2812=500 μm.

Established methods such as phase contrast microscopy, interference reflection microscopy,¹³⁵ total internal reflection fluorescence microscopy¹³⁶ and confocal microscopy¹³⁷ may be used to investigate the cell-biomaterial interface. In addition, monitoring optical diffraction from the gratings during cell culture may provide a means of investigating the dynamic processes of cell adhesion. This method may make it possible to investigate how materials from the cell follow the topography of the surface. The closest method to this idea is reflection interference contrast microscopy, but that method lacks the resolution needed to investigate the surfaces with submicron and sub-100 nm dimensions.

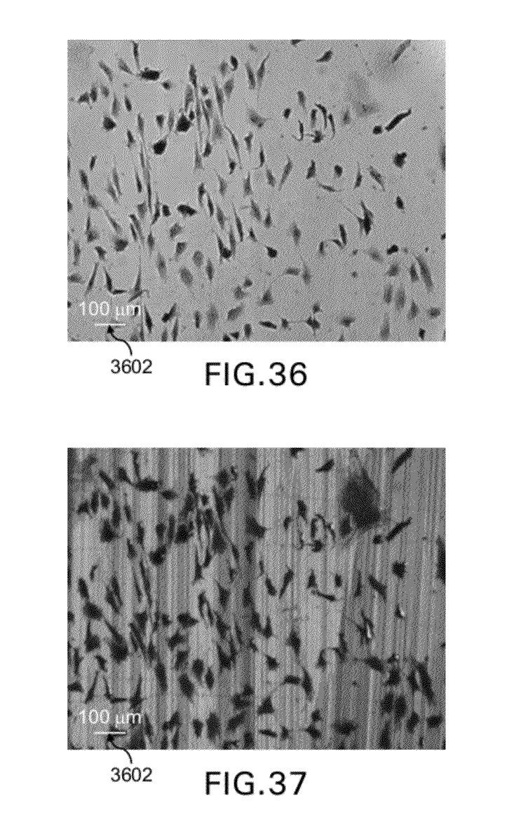

FIGS. 36 and 37 show observation of cell adhesion using optical diffraction. FIG. 36 is a brightfield image of cells stained with toluidine blue. FIG. 37 is an image of the same area, this time with light diffracted from the surface grating. Cell outlines can be seen with a stronger contrast than the stained cells, so observations may be carried out without cell staining. The diffraction image provides new information about how closely the cells contact the surface. Bar 3602=100 μm. The results shown in FIGS. 36 and 37 demonstrate how optical diffraction from the grooved surface topographies can be used to reveal further information about cell interactions with the surface. In this case, the cells were stained with toluidine blue so that they would be visible in the brightfield image of FIG. 36. However, the method also functions with unlabeled cells. In this setup, the cell and extracellular materials produced by the cell fill the grooves in the same way as the water droplet in FIGS. 36 and 37, leading to a change in the refractive index contrast that determines the diffraction intensity.

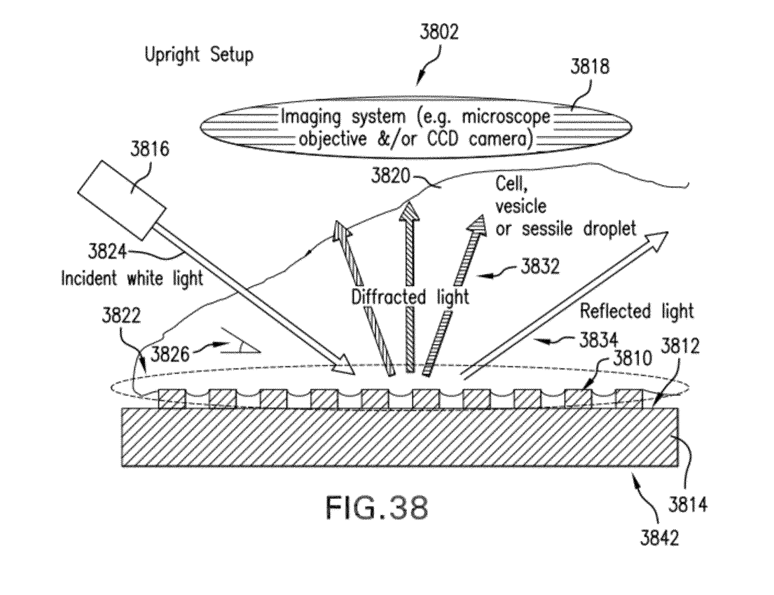

FIG. 38 shows another monitoring apparatus that may be used to observe adherent liquids, model systems and cells on an iridescent surface. FIG. 38 shows an apparatus 3802 according to one embodiment comprising an iridescent surface 3810 on a side 3812 of a substrate 3814, a light source 3816 and an imaging system 3818. An object 3820 to be examined is deposited on iridescent surface 3810. Object 3820 and iridescent surface 3810 interact in an interface region 3822. Incident light 3824 from light source 3816 is directed at an angle 3826 with respect to iridescent surface 3810. Incident light 3824 passes through object 3820 before incident light 3824 is diffracted and reflected by interface region 3822 as diffracted light 3832 and reflected light 3834, respectively. Diffracted light 3832 is detected by imaging system 3818. Substrate 3814 includes a side 3842 of substrate 3814.

Although only one incident angle is shown in FIG. 38, the light source may be adjusted so that the incident light is directed at the iridescent surface at a variety of angles so that the imaging system can detect diffracted light from incident light at multiple angles. Based on the detected diffracted light from the light at multiple incident angles, the adhesion of the object to the iridescent surface may be determined by analysis of the change in intensity detected by the imaging system (detector) for the various wavelengths detected in the scattered light.

The iridescent surface of FIG. 38 may be formed by a lipid multilayer grating, a topographically structured surface such as a diffraction grating (possibly formed from a variety of materials such as polystyrene, polydimethylsiloxane, silicon, glass, etc.), other periodic or non-periodic topographies (including various scattering topographies such as small bumps on the surface), a thin film that is iridescent due to thin film interference, etc.

As shown in FIG. 38, according to one embodiment of the present invention, the object that is examined using the apparatus of FIG. 38 may be a cell, a vesicle or a sessile droplet of a fluid. However, other objects such as biofilms, adhesive tapes, inks, etc. may also be examined using the apparatus of FIG. 38.

The imaging system may be any type of detector such as a microscope, an objective camera, a charge-coupled device (CCD) camera, etc., or a combination of detectors.

Although the incident light in FIG. 38 is shown as being white light, other types of light may also be used as incident light.

The monitoring apparatus shown in FIG. 38 is an upright-type apparatus because the light does not pass through the substrate prior to being diffracted by the iridescent surface. As a result, the substrate does not need to be transparent or translucent.

The substrate of FIG. 38 may be virtually any type of substrate on which lipid multilayer gratings may be deposited or grown or on which an iridescent material may be placed. Such substrates include materials such as glass, plastic, paper, a semiconductor material, etc.

In some embodiments of the present invention, multifunctional surfaces may be developed by the systematic comparison of physicochemical adhesion of model systems, the use of optical diffraction as a label-free readout system, and demonstration of their use in elucidating biological cell adhesion and mechanotransduction. An approach that combines large-area top-down lithography with high-throughput embossing may be used for topographical structuring. Surfaces may be systematically characterized on the basis of their topography, wettability and optical properties, and optimized multifunctional surfaces may be identified. Model systems may be developed on the basis of miniature liquid droplets, surface-adherent multilayers and multicomponent vesicles, which have also been structured on the scale of visible light for better biophotonic properties. These model systems may function as a crucial link between artificial and cell-based methods of determining the biocompatibility of surfaces. Several different types of cells may be cultured on the surfaces and their responses characterized by state-of-the-art imaging and methods in molecular biology, and the results may be compared with those of the model systems in a test of the hypothesis that capillary forces trigger mechanotransduction pathways. In addition to established bioanalytical methods, anisotropic wettability and optical diffraction may be correlated to the cell and model systems, providing a novel label-free method of observing dynamic processes involved in cell-surface interactions.

Iridescence is the change in hue of a surface with varying angles of illumination and/or observation; it is generated by optical diffraction resulting from subwavelength features on the specimen's surface.^{138,139} This form of structural coloration enhances various biological processes (e.g., mate selection, species recognition, defense and photosynthesis) for a wide variety of animal and plant species.^{138,140,141} The invention of the electron microscope is responsible for many of the major breakthroughs in the ultrastructural characterization of iridescence, and electron microscopy is among the most commonly cited methods used.¹³⁸ In one embodiment, the present invention provides a simple method for characterizing iridescence that overcomes cost and portability limitations associated with presently used methods.

While iridescence is typically characterized using electron microscopy,^{138,140,142-148} such methods often involve the use of expensive equipment that may be inaccessible to biologists in the field or to student researchers; keeping this in mind, the procedure presented herein is designed to be easily performed by individuals interested in researching iridescence. Various forms of microscopy, spectroscopy and cytophotometry require the use of expensive, typically nonportable equipment that is often unavailable to students completing research or to biologists interested in characterizing iridescent phenotypes in the field. The methods and materials presented herein are comparatively inexpensive (<500 USD) and portable, and the protocols are easily performed. Further, this unique experimental design generates qualitative results comparable to published quantitative results.

### EXAMPLE

This example uses angle-dependent optical microscopy to generate qualitative information that characterizes iridescence, using the wing of a Morpho butterfly as a standard biological specimen; the presented methods and experimental design can be applied to any iridescent material in biology or in other fields.

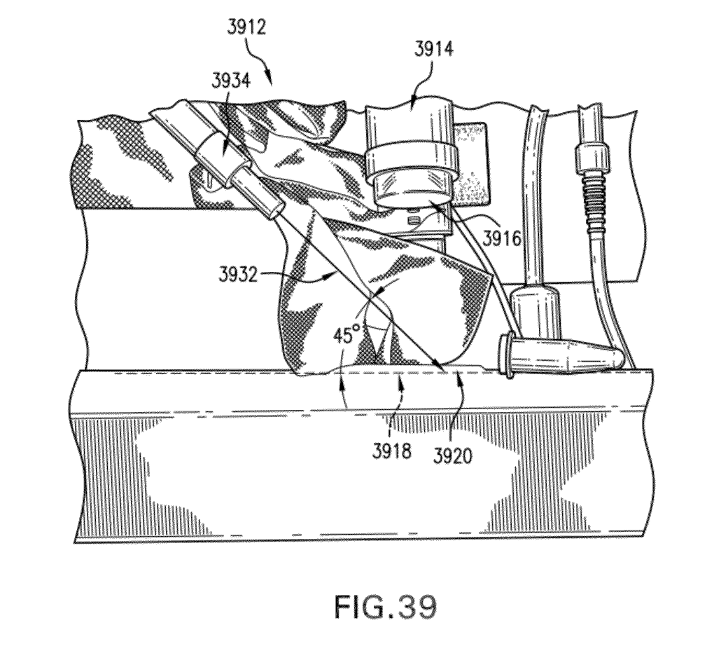

FIG. 39 shows how each angle of incidence is defined and where the camera is positioned relative to the sample. The arrow indicates the position of the camera, which is not altered throughout the course of this experiment. The angle between the beam of light and the surface of the wing is defined. In the following experiments, the “angle” is defined as the point at which the beam of light meets the plane of the surface of the wing. The wing is held stationary by a microcentrifuge tube, which is resting on the edge of the specimen. The microcentrifuge tube is 3.81 cm long.

In the setup used here (shown in FIG. 39), a color digital camera and white light source are arranged at controllable angles relative to the sample surface, and data are recorded at various illumination angles. The results observed are qualitatively consistent with results generated from other studies of iridescence in the Morpho butterfly and, interestingly, in studies of the Selaginella willdenowii, a blue-green iridescent fern.^{410,141} The following summary of recently published papers on iridescence and its proposed biological functions contextualizes the data presented in this paper.

Iridescence has been characterized in a variety of insects, amphibians, birds, and plants.¹⁴⁰ Scientists from various disciplines are interested in iridescence, indicating the relevance and potential applications of improved understanding of this phenomenon. Iridescence is produced by optical diffraction resulting from a combination of both regular and irregular micro-sized and nano-sized structural features on the surfaces of various animal and plant species.¹⁴⁹ While some structural similarities exist between iridescent species in the plant and animal kingdoms, its proposed functions differ.¹⁵⁰ The recently published review by Doucet and Meadows provides a concise outline of the proposed functions of animal iridescence. Among these functions is the visual communication of information between animals (e.g., age and sex).^{141, 151-155} Structural color in animals is also thought to aid animals in eluding predators, either by camouflage or by mimicry.¹⁵⁶⁻¹⁵⁹

Plant and floral iridescence, though not as widely characterized as animal iridescence, has been observed in various plant species. Suggested functions of floral iridescence in pollinating flowers are related to the attraction of pollinating animals.¹³⁸ It is also hypothesized that plants growing in low-light environments evolve structural features that enable them to capture light within the microstructures in their leaves; these microstructures are believed to be responsible for the iridescence of various plant species (e.g., S. willdenowii).^{150,156}

An important next step in the continued characterization of plant iridescence is the investigation of the various kinds of plant species that exhibit this structural color property. Characterization of floral iridescence extends beyond structures that are exclusively iridescent in the visible light range, as the optical properties of pollinating animals (e.g., bees) vary greatly from those of humans, thereby enabling some animals to perceive UV-iridescence exhibited in some floral plant species. It was recently demonstrated for the first time that the red rose is UV-iridescent.¹⁵⁹ Similar observations are likely to be found in various species of flowering plants.¹⁵⁹

Plants also rely on structural color for various purposes related to display and defense. Plants, however, are interested in communicating with pollinating animals rather than with other plants. A likely function of floral iridescence and iridescence in various pollinating species is to assist plants in communicating with pollinators.^{141,160} Plant iridescence is also thought to defend plants from animal predators and from potentially harmful levels of light.¹⁴¹

While some forms of structural coloration are chemically produced, iridescence can be derived only from physical properties .^{143,161} Structural color in butterfly wings is derived from periodically spaced submicrometer structures. The formation mechanisms of these biological structures are extremely complex, as each individual scale's nanoscopic properties contribute to this physical color.¹³⁹ Various attempts at the biomimetic replication of these nanostructures have been made.¹⁶¹ Computer technology has also been integral in the characterization and replication of these structures.¹³⁹

### Materials and Methods

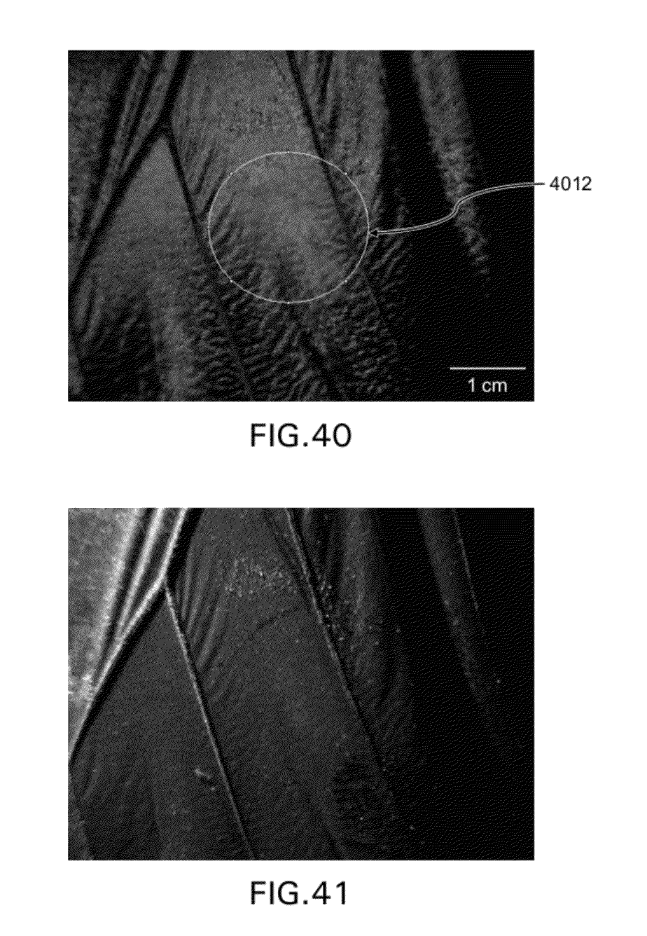

Some previously reported methods for characterizing iridescent structures in various animal and floral species include various forms of microscopy and spectroscopy, e.g., transmission electron microscopy (TEM), scanning electron microscopy (SEM) and atomic force microscopy (AFM)) and various forms of spectroscopy, such as angle-resolved spectroscopy.^{138,140,150,159} FIGS. 40, 41, 42, 43, 44, 45, 46, 47, 48 and 49 illustrate an experiment using optical and light microscopy, thereby providing researchers with a simple method for qualitatively characterizing biological iridescence. In contrast to the methods used in previous experiments, the methods presented herein are simply performed, and the materials are easily obtained and comparatively inexpensive.

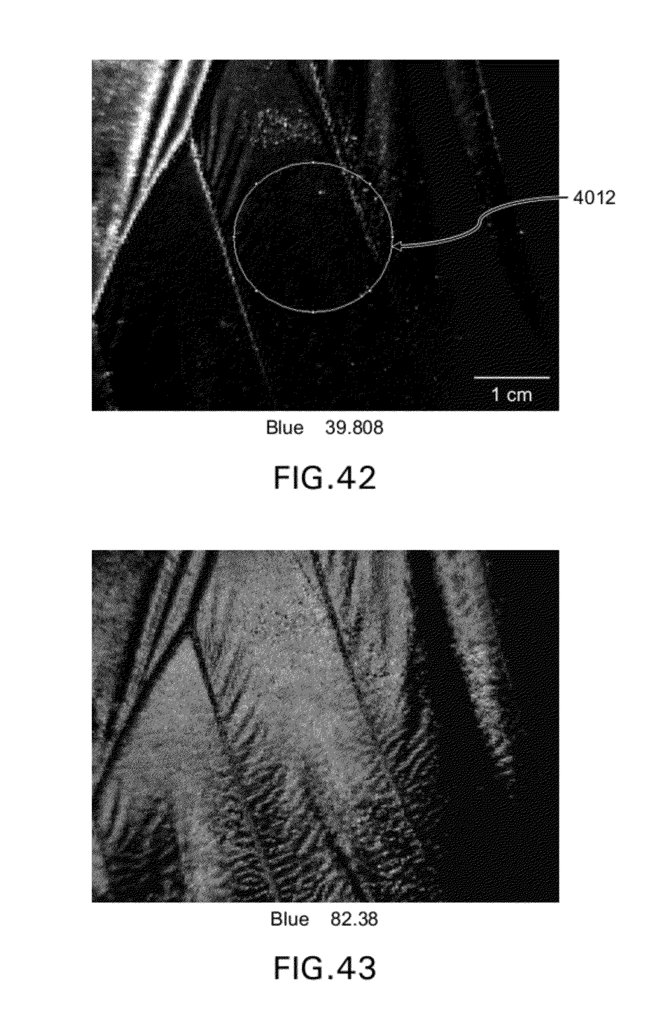

In FIGS. 40 and 41 a butterfly wing can be seen imaged at two different angles of incidence: 17.94° (FIGS. 40), and 57.62° (FIG. 41). These two angles are chosen because they clearly demonstrate the changes in color of the wing with the changing angles of incidence. The images are split into blue, green and red channels as shown in FIGS. 42, 43, 44, 45, 46 and 47. The intensity corresponding to each channel is provided below each image (reported in grayscale values). The difference in the intensities of each color at different angles of incidence can be seen in this figure. Circular region 4012 in FIG. 40 corresponds to the region that is analyzed in data of FIG. 49.

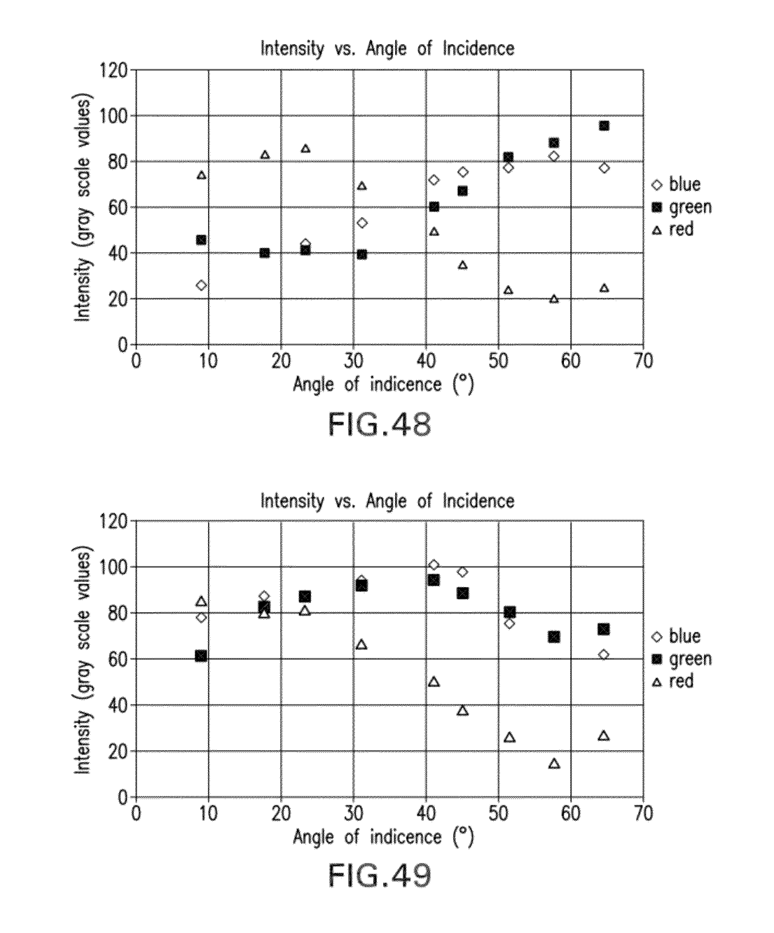

The wing from a blue iridescent Morpho butterfly is the specimen chosen for this project; iridescence in Morpho butterflies is widely characterized.^{139,142,144,162} The specimen imaged is supplied by Jourdan Joly, Tallahassee, Fla. FIG. 39 shows the apparatus used to image the butterfly wing, and FIGS. 40, 41, 42, 43, 44, 45, 46 and 47 show the butterfly wing imaged at two different angles of incidence. The images are split into the three channels, blue, green and red, which are then analyzed to produce the data in FIGS. 48 and 49.

The sample is imaged using a Dino Scope Pro (The Microscope Store, L.L.C., at a magnification of 17×). The microscope is 3 inches above the sample at a 90° angle relative to the plane of the sample. The white light source used is a 500 W Fiber-Lite, High-Intensity Illuminator Series 180 (Dolan-Jenner Industries, Inc.). The lowest intensity setting of the lamp is used to image the sample.

FIG. 39 shows an imaging apparatus 3912 including a camera 3914. A camera lens 3916 of camera 3914 is parallel to the plane 3918 of sample 3920 and at a 45° angle to a beam of light, shown by arrow 3932 from a light source 3934. The angle between the beam of light and the plane of the sample is measured using Screen Protractor software (Iconico, Inc.), and the optimal distance between the light source and the sample is identified as 3 inches. A ruler is used to measure the distance from the light source to the sample at each angle of illumination, and the distances from the light source to the sample range from 3 to 3.5 inches.

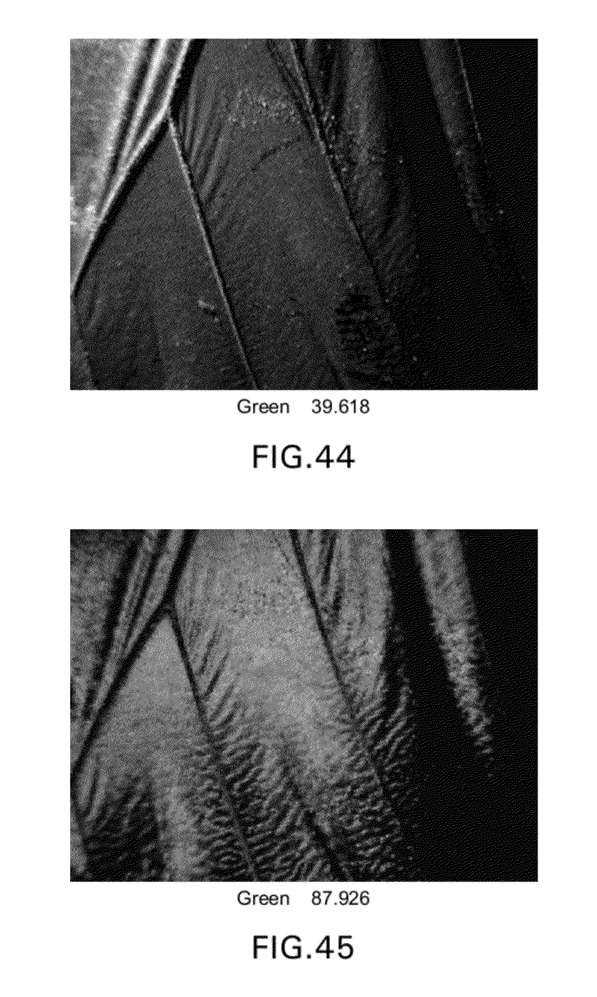

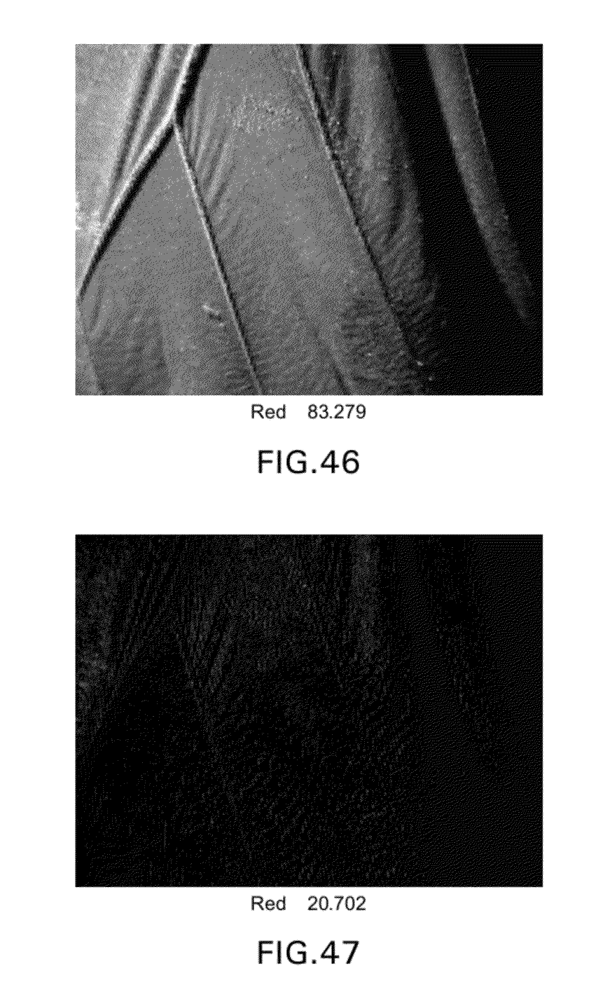

The images photographed with the Dino Scope Pro are analyzed using ImageJ (Research Services Branch, National Institute of Mental Health). The butterfly wing remains stationary while the light source is adjusted according to the desired angle. The images of FIGS. 40, 41, 42, 43, 44, 45, 46 and 47 are images of the butterfly wing taken at two different angles of incidence for all colors (FIGS. 40 and 41), for a blue channel (FIGS. 42 and 43), for a green channel (FIGS. 44 and 45) and for a red channel (FIGS. 46 and 47).

Each image taken is analyzed twice. The data in FIG. 48 are from the analysis of circular region 4012 of the image of the wing in FIG. 40. The data in FIG. 48 demonstrate the changes in intensity of the colors blue, green and red observed as the angle of incidence is varied. Circular region 4012 clearly demonstrates the change of the wing's coloration as the angle of incidence changes. The data in FIG. 49 are from the analysis of the entire wing. The data in FIG. 49 demonstrate that the changes in intensity of the colors blue, green and red observed as the angle of incidence is varied. These data are included as the entire photograph of the wing has some regions that are in shadow. Rather than discarding these regions as artifacts, the function of the shadow in Morpho's natural environment is considered. As suggested in previously published literature on Morpho structural color, iridescence in this butterfly might function as a defense mechanism; the shadowy regions of the wing as seen at various angles of incidence might serve the same function.¹⁴¹ FIGS. 48 and 49 compare the analysis of a small portion of the image with that of the entire image. The intensity values of blue and green fluctuate more than those of red between the two figures.

The specimen is placed on the stage of the microscope and the angle of incidence between the light source and the specimen is varied. The specimen is imaged at various angles of incidence, and the corresponding angle is measured and recorded. The intensity values of blue, green and red (reported in gray scale values) are measured in each image and compared as a function of the angle of incidence. Though the distance of the light from the surface of the specimen varies some as the angle is adjusted, the light source is consistently between 3 and 3.5 inches from the sample. It can be seen that the intensities of blue, green and red vary as the angle of incidence is adjusted (see FIGS. 40, 41, 42, 43, 44, 45, 46 and 47).

A graph providing the relative spectral responses of the Dino Scope Pro camera used in these experiments to the colors blue, green and red is available on microscope manufacturer's website. This graph indicates that the maximum spectral responses for these three wavelengths are 470, 540 and 615 nm, respectively. The intensities observed in the data reported in both FIGS. 48 and 49 indicate that blue is the most intense color observed in the images taken at an angle of incidence less than 41°. This observation is consistent with previous characterizations of Morpho iridescence.^{139,163} The relative intensities of green and red are different between the two figures. In the analysis of the circular region of the image indicated in FIG. 40, as presented in FIG. 48 data, the intensity of green generally increases as the angle of incidence is increased. The intensity values measured at lower angles of incidence are also consistent with the striking blue color of the butterfly wing, which is easily observed when looking at the Morpho butterfly's wings.

In the analysis of the circular portion of the wing, the peak intensity value for red is observed between 0-40°, whereas the peak intensities for blue and green are observed at higher angles of illumination. In the analysis of both FIGS. 48 and 49, it can be seen that blue and green generally have similar intensity measurements. Red intensity values remain comparatively constant between the two figures.

As animal iridescence has been suggested as a way for animals to communicate with each other and to defend themselves against predators, it is conceivable that Morpho iridescence might be an evolved defense or communication method; Frederiksen and co-workers provide an analysis of the Morpho's optical properties that might explain the observed trends between the data presented in FIGS. 48 and 49.¹⁶⁴ The co-development of the coloration systems of predator and prey imply their interconnected nature and interdependence; the characterization of iridescence further develops an understanding of the fundamental biological relationships and mechanisms responsible for the construction of these evolved structural details.

In bright light, the blue-green iridescence of the Selaginella willdenowii becomes reddish-brown. This observation is consistent with the shift in coloration of the Morpho data reported in this experiment.¹⁵⁰ The lower angles shine light more directly on the specimen than the higher angles. The diversity of natural photonic structures in the animal and plant kingdoms indicates the degree to which light functions as a significant selective pressure in various species. Vukisic and Sambles propose that the sensitivity to shadow observed in the iridescent ossicles in a light-sensitive species of brittlestar (Ophiocoma wendtii) functions as a warning in the presence of predators.¹⁴² Perhaps the same is true in the Morpho.

Although in the above example only two angles of incident light were used, in the present invention three or more angles of incident light may be used.

Having described the many embodiments of the present invention in detail, it will be apparent that modifications and variations are possible without departing from the scope of the invention defined in the appended claims. Furthermore, it should be appreciated that all examples in the present disclosure, while illustrating many embodiments of the invention, are provided as nonlimiting examples and are, therefore, not to be taken as limiting the various aspects so illustrated.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it have the full scope defined by the language of the following claims and equivalents thereof.

### REFERENCES

The following references are referred to above and are incorporated herein by reference:
1. S. Lenhert, F. Brinkmann, T. Laue, S. Walheim, C. Vannahme, S. Klinkhammer, M. Xu, S. Sekula, T. Mappes, T. Schimmel, H. Fuchs. Lipid multilayer gratings. Nature Nanotechnology, 5, 275-79 (2010).
2. S. Lenhert, A. Sesma, M. Hirtz, L. Chi, H. Fuchs, H. P. Wiesmann, A. E. Osbourn, B. M. Moerschbacher. Capillary-induced contact guidance. Langmuir, 23, 10216-23 (2007).
3. S. Lenhert, M. B. Meier, U. Meyer, L. F. Chi, H. P. Wiesmann. Osteoblast alignment, elongation and migration on grooved polystyrene surfaces patterned by Langmuir-Blodgett lithography. Biomaterials, 26, 563-70 (2005).
4. A. Curtis, C. Wilkinson. Topographical control of cells. Biomaterials, 18, 1573-83 (1997).
5. C. D. W. Wilkinson, A. S. G. Curtis, J. Crossan. Nanofabrication in cellular engineering. J. Vac. Sci. Technol. B, 16, 3132-36 (1998).
6. M. M. Stevens, J. H. George. Exploring and engineering the cell surface interface. Science, 310, 1135-38 (2005).
7. A. S. G. Curtis, B. Casey, J. O. Gallagher, D. Pasqui, M. A. Wood, C. D. W. Wilkinson. Substratum nanotopography and the adhesion of biological cells: Are symmetry or regularity of nanotopography important? Biophysical Chemistry, 94, 275-83 (2001).
8. H. G. Craighead, C. D. James, A. M. P. Turner. Chemical and topographical patterning for directed cell attachment. Current Opinion in Solid State & Materials Science, 5, 177-84 (2001).
9. H. Kotani, H. Kawaguchi, T. Shimoaka, M. Iwasaka, S. Ueno, H. Ozawa, K.

Nakamura, K. Hoshi. Strong static magnetic field stimulates bone formation to a definite orientation in vitro and in vivo. Journal of Bone and Mineral Research, 17, 1814-21 (2002).
10. J. S. Goldner, J. M. Bruder, G. Li, D. Gazzola, D. Hoffman-Kim. Neurite bridging across micropatterned grooves. Biomaterials, 27, 460-72 (2006).
11. S. Raghavendra, M. C. Wood, T. D. Taylor. Early wound healing around endosseous implants: A review of the literature. International Journal of Oral & Maxillofacial Implants, 20, 425-31 (2005).
12. C. S. Chen, M. Mrksich, S. Huang, G. M. Whitesides, D. E. Ingber. Geometric control of cell life and death. Science, 276, 1425-28 (1997).
13. M. Arnold, E. A. Cavalcanti-Adam, R. Glass, J. Blummel, W. Eck, M. Kantlehner, H. Kessler, J. P. Spatz. Activation of integrin function by nanopatterned adhesive interfaces. Chemphyschem, 5, 383-88 (2004).
14. S. Brody, T. Anilkumar, S. Liliensiek, J. A. Last, C. J. Murphy, A. Pandit. Characterizing nanoscale topography of the aortic heart valve basement membrane for tissue engineering heart valve scaffold design. Tissue Engineering, 12, 413-21 (2006).
15. Y. Ito. Surface micropatterning to regulate cell functions. Biomaterials, 20, 2333-42 (1999).
16. K. B. Lee, S. J. Park, C. A. Mirkin, J. C. Smith, M. Mrksich. Protein nanoarrays generated by dip-pen nanolithography. Science, 295, 1702-05 (2002).
17. N. Sniadecki, R. A. Desai, S. A. Ruiz, C. S. Chen. Nanotechnology for cell-substrate interactions. Annals of Biomedical Engineering, 34, 59-74 (2006).
18. K. von der Mark, J. Park, S. Bauer, P. Schmuki. Nanoscale engineering of biomimetic surfaces: cues from the extracellular matrix. Cell and Tissue Research, 339, 131-53 (2010).
19. R. G. Flemming, C. J. Murphy, G. A. Abrams, S. L. Goodman, P. F. Nealey. Effects of synthetic micro- and nano-structured surfaces on cell behavior. Biomaterials, 20, 573-88 (1999).
20. A. S. Crouch, D. Miller, K. J. Luebke, W. Hu. Correlation of anisotropic cell behaviors with topographic aspect ratio. Biomaterials, 30, 1560-67 (2009).
21. M. L. Carman, T. G. Estes, A. W. Feinberg, J. F. Schumacher, W. Wilkerson, L. H. Wilson, M. E. Callow, J. A. Callow, A. B. Brennan. Engineered antifouling microtopographies-correlating wettability with cell attachment. Biofouling, 22, 11-21 (2006).
22. S. Sekula, J. Fuchs, S. Weg-Remers, P. Nagel, S. Schuppler, J. Fragala, N. Theilacker, M. Franzreb, C. Wingren, P. Ellmark, C. A. K. Borrebaeck, C. A. Mirkin, H. Fuchs, S. Lenhert. Multiplexed lipid dip-pen nanolithography on subcellular scales for templating of functional proteins and cell culture. Small, 4, 1785-93 (2008).
23. T. I. Kim, K. Y. Suh. Unidirectional wetting and spreading on stooped polymer nanohairs. Soft Matter, 5, 4131-35 (2009).
24. M. Gleiche, L. F. Chi, E. Gedig, H. Fuchs. Anisotropic contact-angle hysteresis of chemically nanostructured surfaces. Chemphyschem, 2, 187-91 (2001).
25. M. Gleiche, L. F. Chi, H. Fuchs. Nanoscopic channel lattices with controlled anisotropic wetting. Nature, 403, 173-75 (2000).
26. A. Kumar, G. M. Whitesides. Patterned Condensation Figures as Optical Diffraction Gratings. Science, 263, 60-62 (1994).
27. H. Milan, M. Miroslav, H. Miroslav, S. Dagmar, T. Pavel, Eds. P Proc. SPIE, 5036, 668-73 (2003).
28. J. N. Yih, Y. M. Chu, Y. C. Mao, W. H. Wang, F. C. Chien, C. Y. Lin, K. L. Lee, P. K. Wei, S. J. Chen. Optical waveguide biosensors constructed with subwavelength gratings. Applied Optics, 45, 1938-42 (2006).
29. A. J. Maniotis, C. S. Chen, D. E. Ingber. Demonstration of mechanical connections between integrins cytoskeletal filaments, and nucleoplasm that stabilize nuclear structure. Proceedings of the National Academy of Sciences of the United States of America, 94, 849-54 (1997).
30. C. H. Li, Q. B. Xu. Mechanical stress-initiated signal transductions in vascular smooth muscle cells. Cellular Signalling, 12, 435-45 (2000).
31. B. Geiger, A. Bershadsky, R. Pankov, K. M. Yamada. Transmembrane extracellular matrix-cytoskeleton crosstalk. Nature Reviews Molecular Cell Biology, 2, 793-805 (2001).
32. S. L. Tucker, N. J. Talbot. Surface attachment and pre-penetration stage development by plant pathogenic fungi. Annual Review of Phytopathology, 39, 385+ (2001).
33. S. Buttiglieri, D. Pasqui, M. Migliori, H. Johnstone, S. Affrossman, L. Sereni, M. L. Wratten, R. Barbucci, C. Tetta, G. Camussi. Endothelization and adherence of leucocytes to nanostructured surfaces. Biomaterials, 24, 2731-38 (2003).
34. D. E. Ingber, Tensegrity II: How structural networks influence cellular information processing networks. Journal of Cell Science, 116, 1397-1408 (2003).
35. D. E. Ingber, Tensegrity I: Cell structure and hierarchical systems biology. Journal of Cell Science, 116, 1157-73 (2003).
36. K. R. Legate, E. Montanez, O. Kudlacek, R. Fassler. ILK, PINCH and parvin: the tIPP of integrin signalling. Nature Reviews Molecular Cell Biology, 7, 20-31 (2006).
37. R. Phillips, T. Ursell, P. Wiggins, P. Sens. Emerging roles for lipids in shaping membrane-protein function. Nature, 459, 379-85 (2009).
38. T. Y. Yoon, C. Jeong, S. W. Lee, J. H. Kim, M. C. Choi, S. J. Kim, M. W. Kim, S. D. Lee. Topographic control of lipid-raft reconstitution in model membranes. Nature Materials, 5, 281-85 (2006).
39. R. Lipowsky. The Conformation of Membranes. Nature, 349, 475-81 (1991).
40. H. T. McMahon, J. L. Gallop. Membrane curvature and mechanisms of dynamic cell membrane remodelling. Nature, 438, 590-96 (2005).
41. A. M. Rajnicek, C. D. McCaig. Guidance of CNS growth cones by substratum grooves and ridges: effects of inhibitors of the cytoskeleton calcium channels and signal transduction pathways. Journal of Cell Science, 110, 2915-24 (1997).
42. M. J. Dalby, N. Gadegaard, M. O. Riehle, C. D. W. Wilkinson, A. S. G. Curtis. Investigating filopodia sensing using arrays of defined nano-pits down to 35 nm diameter in size. International Journal of Biochemistry & Cell Biology, 36, 2005-15 (2004).
43. M. J. Dalby, M. O. Riehle, H. Johnstone, S. Affrossman, A. S. G. Curtis. Investigating the limits of filopodial sensing: a brief report using SEM to image the interaction between 10 nm high nano-topography and fibroblast filopodia. Cell Biology International, 28, 229-36 (2004).
44. M. J. Dalby, M. O. Riehle, D. S. Sutherland, H. Agheli, A. S. G. Curtis. Changes in fibroblast morphology in response to nano-columns produced by colloidal lithography. Biomaterials, 25, 5415-22 (2004).
45. A. I. Teixeira, G. A. Abrams, P. J. Bertics, C. J. Murphy, P. F. Nealey. Epithelial contact guidance on well-defined micro- and nanostructured substrates. Journal of Cell Science, 116, 1881-92 (2003).
46. O. P. Hamill, B. Martinac. Molecular basis of mechanotransduction in living cells. Physiological Reviews, 81, 685-740 (2001).
47. M. J. Dalby. Topographically induced direct cell mechanotransduction. Medical Engineering & Physics, 27, 730-42 (2005).
48. D. E. Ingber. Cellular mechanotransduction: putting all the pieces together again. Faseb Journal, 20, 811-27 (2006).
49. P. Weiss. Experiments on cell and axon orientation in vitro: The role of colloidal exudates in tissue organization. J. Exp. Zool., 100, 353-86 (1945).
50. P. Weiss. In vitro experiments on the factors determining the course of outgrowing nerve fiber. J. Exp. Zool., 68, 393-448 (1934).
51. F. Brochard-Wyart, in Soft Matter Physics, C. E. W. M. Daoud, Ed. (Springer-Verlag, Berlin Heidelberg New York, 1995), pp. 1-45.
52. P. G. d. Gennes. Wetting: statics and dynamics. Reviews of Modern Physics, 57, 827-63 (1985).
53. A. Pierres, P. Eymeric, E. Baloche, D. Touchard, A. M. Benoliel, P. Bongrand. Cell membrane alignment along adhesive surfaces: Contribution of active and passive cell processes. Biophysical Journal, 84, 2058-70 (2003).
54. E. Evans, in Structure and dynamics of membranes, R. Lipowsky, E. Sackmann, Eds. (Elsevier Science, 1995), vol. 1B, pp. 723-54.
55. E. Sackmann, R. F. Bruinsma. Cell adhesion as wetting transition? Chemphyschem, 3, 262-69 (2002).
56. S. M. Rafelski, J. A. Theriot. Crawling toward a unified model of cell motility: Spatial and temporal regulation of actin dynamics. Annual Review of Biochemistry, 73, 209-39 (2004).
57. A. Mendez-Vilas, A. B. Jodar-Reyes, M. L. Gonzalez-Martin. Ultrasmall liquid droplets on solid surfaces: production, imaging, and relevance for current wetting research. Small, 5, 1366-90 (2009).
58. T. Baumgart, S. T. Hess, W. W. Webb. Imaging coexisting fluid domains in biomembrane models coupling curvature and line tension. Nature, 425, 821-24 (2003).
59. S. L. Veatch, S. L. Keller. Seeing spots: Complex phase behavior in simple membranes. Biochimica Et Biophysica Acta-Molecular Cell Research, 1746, 172-85 (2005).
60. A. Tian, T. Baumgart. Sorting of lipids and proteins in membrane curvature gradients. Biophysical Journal, 96, 2676-88 (2009).
61. T. Mappes, S. Lenhert, 0. Kassel, C. Vannahme, M. Schelb, J. Mohr, in Digest of IEEE/LEOS (Acapulco, Mexico, 2008), pp. 215-16.
62. S. Sekula, J. Fuchs, S. Weg-Remers, P. Nagel, S. Schuppler, J. Fragala, N. Theilacker,

M. Franueb, C. Wingren, P. Ellmark, C. A. K. Borrebaeck, C. A. Mirkin, H. Fuchs, S. Lenhert. Multiplexed Lipid Dip-Pen Nanolithography on Subcellular Scales for the Templating of Functional Proteins and Cell Culture. Small, 4, 1785-93 (2008).
63. Y. H. Wang, L. R. Giam, M. Park, S. Lenhert, H. Fuchs, C. A. Mirkin. A Self-Correcting Inking Strategy for Cantilever Arrays Addressed by an Inkjet Printer and Used for Dip-Pen Nanolithography. Small, 4, 1666-70 (2008).
64. S. Lenhert, H. Fuchs, C. A. Mirkin, in Nanoprobes, H. Fuchs, Ed. (Wiley-VCH, Weinheim, 2009), vol. 6.
65. S. Lenhert, F. Brinkmann, T. Laue, S. Walheim, C. Vannahme, S. Klinkhammer, M. Xu, S. Sekula, T. Mappes, T. Schimmel, H. Fuchs. Lipid multilayer gratings (Submitted).
66. S. Lenhert, P. Sun, Y. H. Wang, H. Fuchs, C. A. Mirkin. Massively parallel dip-pen nanolithography of heterogeneous supported phospholipid multilayer patterns. Small, 3, 71-75 (2007).
67. Y. Wang, L. R. Giam, M. Park, S. Lenhert, H. Fuchs, C. A. Mirkin. A self-correcting inking strategy for cantilever arrays addressed by an inkjet printer and used for dip-pen nanolithography. Small, 4, 1666-70 (2008).
68. X. C. Wu, S. Lenhert, L. F. Chi, H. Fuchs. Interface interaction controlled transport of CdTe nanoparticles in the microcontact printing process. Langmuir, 22, 7807-11 (2006).
69. S. Lenhert, M. Gleiche, H. Fuchs, L. F. Chi. Mechanism of regular pattern formation in reactive dewetting. Chemphyschem, 6, 2495-98 (2005).
70. S. Lenhert, L. Zhang, J. Mueller, H. P. Wiesmann, G. Erker, H. Fuchs, L. F. Chi. Self-organized complex patterning: Langmuir-Blodgett lithography. Advanced Materials, 16, 619-24 (2004).
71. O. A. Nafday, B. L. Weeks. Feature size dependence on hysteresis due to relative humidity ramping and patterning order in dip-pen nanolithography. Journal of Experimental Nanoscience, 2, 229-37 (2007).
72. O. A. Nafday, B. L. Weeks. Relative humidity effects in dip-pen nanolithography of alkanethiol mixtures. Langmuir, 22, 10912-14 (2006).
73. 0. A. Nafday, M. W. Vaughn, B. L. Weeks. Evidence of meniscus interface transport in dip-pen nanolithography: An annular diffusion model. Journal of Chemical Physics, 125, 144703 (2006).
74. J. Haaheim, O. A. Nafday. Desktop Biological Nanopatterning Using Dip-Pen Nanolithography. American Laboratory, 40, 54+(2008).
75. J. Haaheim, O. A. Nafday. Dip pen Nanolithography®: A “Desktop Nanofab (TM)” approach using high-throughput flexible nanopatterning. Scanning, 30, 137-50 (2008).
76. J. Radler, H. Strey, E. Sackmann. Phenomenology and Kinetics of Lipid Bilayer Spreading on Hydrophilic Surfaces. Langmuir, 11, 4539-48 (1995).
77. J. Nissen, S. Gritsch, G. Wiegand, J. O. Radler. Wetting of phospholipid membranes on hydrophilic surfaces—Concepts towards self-healing membranes. European Physical Journal B, 10, 335-44 (1999).
78. J. Nissen, K. Jacobs, J. O. Radler. Interface dynamics of lipid membrane spreading on solid surfaces. Physical Review Letters, 86, 1904-07 (2001).
79. B. Sanii, A. N. Parikh. Surface-energy dependent spreading of lipid monolayers and bilayers. Soft Matter, 3, 974-77 (2007).
80. G. McHale, N. J. Shirtcliffe, S. Aqil, C. C. Perry, M. I. Newton. Topography driven spreading. Physical Review Letters, 93, 036102 (2004).
81. J. Solon, P. Streicher, R. Richter, F. Brochard-Wyart, P. Bassereau. Vesicles surfing on a lipid bilayer: Self-induced haptotactic motion. Proceedings of the National Academy of Sciences of the United States of America, 103, 12382-87 (2006).
82. F. Morhard, J. Pipper, R. Dahint, M. Grunze. Immobilization of antibodies in micropatterns for cell detection by optical diffraction. Sensors and Actuators B-Chemical, 70, 232-42 (2000).
83. F. L. Dickert, P. Lieberzeit, O. Hayden. Sensor strategies for microorganism detection —from physical principles to imprinting procedures. Analytical and Bioanalytical Chemistry, 377, 540-49 (2003).
84. D. B. Weibel, W. R. DiLuzio, G. M. Whitesides. Microfabrication meets microbiology. Nature Reviews Microbiology, 5, 209-18 (2007).
85. J. R. Choi, H. J. Ryu, T. I. Oh, D. Kim. A diffraction-based study of cell viability using a periodic blazed grating. 2007 Pacific Rim Conference on Lasers and Electro-Optics, 1-4, 571-72, 1441 (2007).
86. K. A. Kilian, L. M. H. Lai, A. Magenau, S. Cartland, T. Bocking, N. Di Girolamo, M. Gal, K. Gaus, J. J. Gooding. Smart Tissue Culture: In Situ Monitoring of the Activity of Protease Enzymes Secreted from Live Cells Using Nanostructured Photonic Crystals. Nano Letters, 9, 2021-25 (2009).
87. N. Massad-Ivanir, G. Shtenberg, T. Zeidman, E. Segal. Construction and Characterization of Porous SiO2/Hydrogel Hybrids as Optical Biosensors for Rapid Detection of Bacteria. Advanced Functional Materials, 20, 2269-77 (2010).
88. M. P. Schwartz, A. M. Derfus, S. D. Alvarez, S. N. Bhatia, M. J. Sailor. The smart petri dish: A nanostructured photonic crystal for real-time monitoring of living cells. Langmuir, 22, 7084-90 (2006).
89. J. Beuthan, O. Minet, J. Helfmann, M. Herrig, G. Muller. The spatial variation of the refractive index in biological cells. Physics in Medicine and Biology, 41, 369-82 (1996).
90. S. D. Gillmor, J. J. Heetderks, P. S. Weiss. Temperature-Dependent Vesicle Response to Surface Topography. Journal of Physical Chemistry B, 113, 11490-95 (2009).
91. R. D. Piner, J. Zhu, F. Xu, S. H. Hong, C. A. Mirkin. “Dip-pen” nanolithography. Science, 283, 661-63 (1999).
92. K. Salaita, Y. H. Wang, J. Fragala, R. A. Vega, C. Liu, C. A. Mirkin. Massively parallel dip-pen nanolithography with 55000-pen two-dimensional arrays. Angewandte Chemie-International Edition, 45, 7220-23 (2006).
93. M. Geissler, H. Schmid, B. Michel, E. Delamarche. Selective wet-etching of microcontact-printed Cu substrates with control over the etch profile. Microelectronic Engineering, 67-8, 326-32 (2003).
94. H. Zhang, N. A. Amro, S. Disawal, R. Elghanian, R. Shile, J. Fragala. High-throughput dip-pen-nanolithography-based fabrication of Si nanostructures. Small, 3, 81-85 (2007).
95. N. Lu, M. Gleiche, J. W. Zheng, S. Lenhert, B. Xu, L. F. Chi, H. Fuchs. Fabrication of chemically patterned surfaces based on template-directed self-assembly. Advanced Materials, 14, 1812-15 (2002).
96. J. Lovmand, E. Justesen, M. Foss, R. H. Lauridsen, M. Lovmand, C. Modin, F. Besenbacher, F. S. Pedersen, M. Duch. The use of combinatorial topographical libraries for the screening of enhanced osteogenic expression and mineralization. Biomaterials, 30, 2015-22 (2009).
97. W. Barthlott, C. Neinhuis. Purity of the sacred lotus, or escape from contamination in biological surfaces, Planta, 202, 1-8 (1997).
98. L. Feng, S. H. Li, Y. S. Li, H. J. Li, L. J. Zhang, J. Zhai, Y. L. Song, B. Q. Liu, L. Jiang, D. B. Zhu. Super-hydrophobic surfaces: From natural to artificial. Advanced Materials, 14, 1857-60 (2002).
99. T. L. Sun, L. Feng, X. F. Gao, L. Jiang. Bioinspired surfaces with special wettability. Accounts of Chemical Research, 38, 644-52 (2005).
100. X. F. Gao, L. Jiang. Water-repellent legs of water striders. Nature, 432, 36 (2004).
101. B. Bhushan. Biomimetics: lessons from nature—an overview. Philosophical Transactions of the Royal Society a-Mathematical Physical and Engineering Sciences, 367, 1445-86 (2009).
102. K. Autumn, N. Grayish. Gecko adhesion: evolutionary nanotechnology. Philosophical Transactions of the Royal Society αa-Mathematical Physical and Engineering Sciences, 366, 1575-90 (2008).
103. T. Young. An Essay on the Cohesion of Fluids. Phil. Trans. R. Soc. Lond., 95, 65-87 (1805).
104. R. N. Wenzel. Resistance of solid surfaces to wetting by water. Ind. Eng. Chem., 28, 988-94 (1936).
105. A. B. D. Cassie, S. Baxter. Wettability of porous surfaces. Transactions of the Faraday Society, 40, 546-51 (1944).
106. G. Whyman, E. Bormashenko, T. Stein. The rigorous derivation of Young, Cassie-Baxter and Wenzel equations and the analysis of the contact angle hysteresis phenomenon. Chemical Physics Letters, 450, 355-59 (2008).
107. R. G. Cox. The spreading of a liquid on a rough solid surface. J. Fluid mech., 131, 1-26 (1983).
108. D. Rittenhouse. Explanation of an optical deception. Trans. Amer. Phil. Soc., 2, 37-42 (1786).
109. J. v. Fraunhofer. Joseph von Fraunhofer: Neue Modification des Lichtes durch gegenseitige Einwirkung und Beugung der Strahlen, Denkschrift der königlichen Akademie der Wissenschaften zu München für die Jahre 1821 und 1822, 8, 3-76 (1824).
110. H. Nabika, B. Takimoto, K. Murakoshi. Molecular separation in the lipid bilayer medium: electrophoretic and self-spreading approaches. Analytical and Bioanalytical Chemistry, 391, 2497-2506 (2008).
111. A. D. Douglass, R. D. Vale. Single-molecule microscopy reveals plasma membrane microdomains created by protein-protein networks that exclude or trap signaling molecules in T cells. Cell, 121, 937-50 (2005).
112. K. D. Mossman, G. Campi, J. T. Groves, M. L. Dustin. Altered TCR signaling from geometrically repatterned immunological synapses. Science, 310, 1191-93 (2005).
113. S. Munro. Lipid rafts: Elusive or illusive? Cell, 115, 377-88 (2003).
114. C. Dietrich, L. A. Bagatolli, Z. N. Volovyk, N. L. Thompson, M. Levi, K. Jacobson, E. Gratton. Lipid rafts reconstituted in model membranes. Biophysical Journal, 80, 1417-28 (2001).
115. D. H. Gracias, J. Tien, T. L. Breen, C. Hsu, G. M. Whitesides. Forming electrical networks in three dimensions by self-assembly. Science, 289, 1170-72 (2000).
116. M. Rentzhog, A. Fogden. Print quality and resistance for water-based flexography on polymer-coated boards: Dependence on ink formulation and substrate pretreatment. Progress in Organic Coatings, 57, 183-94 (2006).
117. A. Diguet, M. Le Berre, Y. Chen, D. Baigl. Preparation of Phospholipid Multilayer Patterns of Controlled Size and Thickness by Capillary Assembly on a Microstructured Substrate. Small, 5, 1661-66 (2009).
118. L. C. Gao, T. J. McCarthy. Wetting 101 degrees. Langmuir, 25, 14105-15 (2009).
119. V. Sahni, T. A. Blackledge, A. Dhinojwala. Viscoelastic solids explain spider web stickiness. Nature Communications, 1, 19 (2010).
120. T. Hayashi, R. W. Carthew. Surface mechanics mediate pattern formation in the developing retina. Nature, 431, 647-52 (2004).
121. T. Lecuit, P. F. Lenne. Cell surface mechanics and the control of cell shape, tissue patterns and morphogenesis. Nature Reviews Molecular Cell Biology, 8, 633-44 (2007).
122. D. E. Ingber. From Cellular Mechanotransduction to Biologically Inspired Engineering. Annals of Biomedical Engineering, 38, 1148-61 (2010).
123. K. N. Dahl, A. J. S. Ribeiro, J. Lammerding. Nuclear shape, mechanics, and mechanotransduction. Circulation Research, 102, 1307-18 (2008).
124. A. Katsumi, A. W. Orr, E. Tzima, M. A. Schwartz. Integrins in mechanotransduction. Journal of Biological Chemistry, 279, 12001-04 (2004).
125. A. D. Bershadsky, N. Q. Balaban, B. Geiger. Adhesion-dependent cell mechanosensitivity. Annual Review of Cell and Developmental Biology, 19, 677-95 (2003).
126. E. K. F. Yim, E. M. Darling, K. Kulangara, F. Guilak, K. W. Leong. Nanotopography-induced changes in focal adhesions, cytoskeletal organization, and mechanical properties of human mesenchymal stem cells. Biomaterials, 31, 1299-1306 (2010).
127. I. Patla, T. Volberg, N. Elad, V. Hirschfeld-Warneken, C. Grashoff, R. Fassler, J. P. Spatz, B. Geiger, O. Medalia. Dissecting the molecular architecture of integrin adhesion sites by cryo-electron tomography. Nature Cell Biology, 12, 909-15 (2010).
128. S. Huang, D. E. Ingber. The structural and mechanical complexity of cell-growth control. Nature Cell Biology, 1, E131-E138 (1999).
129. D. S. Salloum, S. G. Olenych, T. C. S. Keller, J. B. Schlenoff. Vascular smooth muscle cells on polyelectrolyte multilayers: Hydrophobicity-directed adhesion and growth. Biomacromolecules, 6, 161-67 (2005).
130. S. G. Olenych, M. D. Moussallem, D. S. Salloum, J. B. Schlenoff, T. C. S. Keller. Fibronectin and cell attachment to cell and protein resistant polyelectrolyte surfaces. Biomacromolecules, 6, 3252-58 (2005).
131. M. D. Moussallem, S. G. Olenych, S. L. Scott, T. C. S. Keller, J. B. Schlenoff. Smooth Muscle Cell Phenotype Modulation and Contraction on Native and Cross-Linked Polyelectrolyte Multilayers. Biomacromolecules, 10, 3062-68 (2009).
132. J. B. Schlenoff, D. S. Salloum, D. A. Jaber, S. G. Olenych, T. C. S. Keller. Hydrophobicity-induced adhesion differentiation and growth of cells using polyelectrolyte multilayers. Abstracts of Papers of the American Chemical Society, 229, U648-U648 (2005).
133. M. R. Block, C. Badowski, A. Millon-Fremillon, D. Bouvard, A. P. Bouin, E. Faurobert, D. Gerber-Scokaert, E. Planus, C. Albiges-Rizo. Podosome-type adhesions and focal adhesions, so alike yet so different, European Journal of Cell Biology. 87, 491-506 (2008).
134. R. G. Newcomer, M. D. Moussallem, T. C. S. Keller, J. B. Schlenoff, Q. A. Sang. Human Coronary Artery Smooth Muscle Cell Responses to Bioactive Polyelectrolyte Multilayer Interfaces. Biotechnology Research International. (In press) (2010).
135. X. F. Walboomers, W. Monaghan, A. S. G. Curtis, J. A. Jansen. Attachment of fibroblasts on smooth and microgrooved polystyrene. Journal of Biomedical Materials Research, 46, 212-20 (1999).
136. J. T. Groves, R. Parthasarathy, M. B. Forstner. Fluorescence imaging of membrane dynamics, Annual Review of Biomedical Engineering. 10, 311-38 (2008).
137. P. Uttayarat, G. K. Toworfe, F. Dietrich, P. I. Lelkes, R. J. Composto. Topographic guidance of endothelial cells on silicone surfaces with micro- to nanogrooves: Orientation of actin filaments and focal adhesions. Journal of Biomedical Materials Research Part A, 75A, 668-80 (2005).
138. H. M. Whitney, M. Kolle, P. Andrew, L. Chittka, U. Steiner, B. J. Glover. Floral iridescence, produced by diffractive optics, acts as a cue for animal pollinators. Science, 323, 130 (2009).
139. G. S. Smith. Structural color of Morpho butterflies. American Journal of Physics, 77, 1010 (2009).
140. P. Vukusic. Natural designs for manipulating the appearance of surfaces. Ophthalmic and Physiological Optics, 30, 435 (2010).
141. S. M. Doucet, M. G. Meadows. Iridescence: a functional perspective. Journal of the Royal Society Interface, 6, S115 (2009).
142. P. Vukusic, J. R. Sambles. Photonic structures in biology. Nature, 424, 852 (2003).
143. E. Bradshaw, P. J. Rudall, D. S. Devey, M. M. Thomas, B. J. Glover, R. M. Bateman. Comparative labellum micromorphology of the sexually deceptive temperate orchid genus Ophrys: diverse epidermal cell types and multiple origins of structural colour. Botanical Journal of the Linnean Society, 162, 504 (2010).
144. R. O. Prum, T. Quinn, R. H. Torres. Anatomically diverse butterfly scales all produce structural colours by coherent scattering. Journal of Experimental Biology, 209, 748 (2006).
145. M. D. Shawkey, N. I. Morehouse, P. Vukusic. A Protean palette: color materials and mixing in birds and butterflies. Journal of the Royal Society Interface, 6, 5221 (2009).
146. A. E. Seago, P. Brady, J. P. Vigneron. Gold bugs and beyond: A review of iridescence and structural color mechanisms in beetles (Coleoptera). T. D. Schultz, Journal of the Royal Society Interface, 6, S165 (2009).
147. B. D. Wilts, H. L. Leertouwer, D. G. Stavenga. Imaging scatterometry and microspectrophotometry of lycaenid butterfly wing scales with perforated multilayers. Journal of the Royal Society Interface, 6, 5185 (2009).
148. L. Poladian, S. Wickham, K. Lee, M. C. J. Large. Iridescence from photonic crystals and its suppression in butterfly scales. Journal of the Royal Society Interface, 6, 5233 (2009).
149. S. M. Lee, J. Upping, A. Bielawny, M. Knez. Structure-based color of natural petals discriminated by polymer replication. ACS Applied Materials & Interfaces, 3, 30 (2011).
150. K. R. Thomas, M. Kolle, H. M. Whitney, B. J. Glover, U. Steiner. Function of blue iridescence in tropical understorey plants. Journal of the Royal Society Interface, 7, 1699 (2010).
151. R. L. Rutowski. The use of visual cues in sexual and species discrimination by males of the small sulphur butterfly Eurema lisa (Lepidoptera, Pieridae). Journal of Comparative Physiology, 115, 61 (1977).
152. R. L. Rutowski. Chemical communication in the courtship of the small sulphur butterfly Eurema lisa (Lepidoptera, Pieridae). Journal of Comparative Physiology, 115, 75 (1977).
153. R. E. Silberglied, O. R. Taylor. Ultraviolet reflection and its behavioral role in the courtship of the sulphur butterflies, Colias eurytheme and C. philodice (Lepidoptera, Pieridae). Behavioral Ecology and Sociobiology, 3, 203 (1978).
154. D. J. Kemp. Heightened phenotypic variation and age-based fading of ultraviolet butterfly wing coloration. Evolutionary Ecology Research, 8, 515 (2006).
155. P. P. Bitton, R. D. Dawson. Age-related differences in plumage characteristics of male tree swallows Tachycineta bicolor: hue and brightness signal different aspects of individual quality. Journal of Avian Biology, 39, 446 (2008).
156. B. J. Glover, H. M. Whitney. Structural colour and iridescence in plants: the poorly studied relations of pigment colour. Annals of Botany, 105, 505 (2010).
157. T. D. Schultz, G. D. Bernard. Pointillistic mixing of interference colours in cryptic tiger beetles. Nature, 337, 72 (1989).
158. T. D. Schultz. The role of structural colors in predator avoidance by tiger beetles of the genus Cicindela. Bulletin of the Entomological Society of America, 32, 142 (1986).
159. L. Feng, Y. A. Zhang, M. Z. Li, Y. M. Zheng, W. Z. Shen, L. Jiang. The structural color of red rose petals and their duplicates. Langmuir, 26, 14885 (2010).
160. C. Hebánt, D. W. Lee. Ultrastructural developmental control of iridescence in Selaginella leaves. American Journal of Botany, 71, 216 (1984).
161. Z. Shenmin et al. A simple and effective approach towards biomimetic replication of photonic structures from butterfly wings. Nanotechnology, 20, 315303 (2009).
162. S. Kinoshita, S. Yoshioka, K. Kawagoe. Mechanisms of structural colour in the Morpho butterfly: cooperation of regularity and irregularity in an iridescent scale. Proceedings of the Royal Society of London Series B-Biological Sciences, 269, 1417 (2002).
163. P. Vukusic, D. G. Stavenga. Physical methods for investigating structural colours in biological systems. Journal of the Royal Society Interface, 6, S133 (2009).
164. R. Frederiksen, E. J. Warrant. Visual sensitivity in the crepuscular owl butterfly Caligo memnon and the diurnal blue morpho Morpho peleides: a clue to explain the evolution of nocturnal apposition eyes? J. Exp. Biol., 211, 844 (2008).

What is claimed is:

1. A method comprising the following step:
(a) determining the adhesion of an object to an iridescent surface based on scattered light detected by a detector,
wherein the scattered light is formed by scattering one or more incident lights by an interface region for the object and the iridescent surface.

2. The method of claim 1, wherein the scattered light is formed by scattering two or more incident lights by the interface region, and wherein each of the two or more incident lights is at a different incident angle with respect to the iridescent surface.

3. The method of claim 1, wherein the scattered light is formed by scattering three or more incident lights by the interface region, and wherein each of the three or more incident lights is at a different incident angle with respect to the iridescent surface.

4. The method of claim 1, wherein the iridescent surface comprises one or more biomolecules.

5. The method of claim 4, wherein the biomolecules comprise one or more lipid multilayer gratings.

6. The method of claim 5, wherein the lipid multilayer gratings comprise one or more phospholipids.

7. The method of claim 6, wherein the scattered light passes through the object prior to being detected by the detector.

8. The method of claim 1, wherein the iridescent surface is on a transparent or translucent substrate and wherein the scattered light passes through the substrate prior to being detected by the detector.

9. The method of claim 1, wherein the object is a cell.

10. The method of claim 1, wherein the object is a fluid droplet.

11. The method of claim 10, wherein the fluid droplet is a droplet of a liquid.

12. The method of claim 11, wherein the fluid droplet is a droplet of a gel.

13. The method of claim 1, wherein the one or more incident lights are each white light.

14. The method of claim 1, wherein in step (a) the object is determined not to adhere to the iridescent surface.

15. The method of claim 1, wherein the method comprises the following step:
(b) detecting the scattered light scattered by the interface region.

16. The method of claim 15, wherein the method comprises the following step:
(c) directing the one or more incident lights through the object so that the one or more incident lights are scattered by the interface region to form the the scattered light.

17. The method of claim 15, wherein the iridescent surface is on a transparent or translucent substrate and wherein the method comprises the following step:
(c) directing the one or more incident lights through transparent or translucent substrate so that the one or more incident lights are scattered by the interface region to form the the scattered light.
